(19) United States
(12) Patent Application Publication
(10) Pub. No.: US 2007/0005629 A1
(43) Pub. Date: Jan. 4, 2007

(54) Memory device for a rail longitudinal guide for a motor vehicle seat

(76) Inventors: Hirokazu Tokuda, Osaka (JP); Yuko Tsusaka, Osaka (JP); Kentaro Tanikawa, Osaka (JP)

Correspondence Address: WENDEROTH, LIND & PONACK L.L.P., 2033 K. STREET, NW, SUITE 800, WASHINGTON, DC, 20006, US

(21) Appl. No.: 10/573,388

(22) PCT Filed: Oct. 14, 2004
(86) PCT No.: PCT/JP04/15571

§ 371 Date: Mar. 24, 2006

(51) Int. Cl. G06F 7/00

(52) U.S. Cl. 707/102

(57) ABSTRACT

A program recording apparatus for receiving and recording a program. The program recording apparatus includes: a receiving unit operable to receive a first program and a second program; a recording unit operable to record the received first and second programs; an acquiring unit operable to acquire a first title of the first program and a second title of the second program; an extracting unit operable to extract a first difference from the first title, and extracts a second difference from the second title, the first and second differences being respectively portions of the first and second titles and being different from each other; and a program list generating unit operable to generate a program list based on the first and second differences extracted by the extracting unit.

### TECHNICAL FIELD

The present invention relates to a program recording apparatus for recording and reproducing a program, and specifically, to a technology for generating a title list of the recorded programs.

### BACKGROUND ART

Program recording apparatuses allow the users to record broadcast programs therein and play back the recorded programs at their free time or the like.

The users can record more broadcast programs than before due to the lately started digital broadcasting that broadcast programs on a number of channels using digital broadcast waves, and due to the prevalence of program recording apparatuses having a higher-capacity recording medium. The increase in the number of programs the users can record makes it difficult for the users to select a program to watch among a lot of recorded programs.

This problem is addressed by a technology in which a program recording apparatus automatically creates a title list that includes titles of recorded programs.

However, only a limited number of characters can be used to generate a title to be contained in the title list. Generally, the title list is composed of sequences of a predetermined number of characters that have each been extracted from the beginning of a corresponding program title. Accordingly, when a group of programs (hereinafter, referred to as a program series) composed of a plurality of programs that each have a same main title and a different sub title is recorded, all titles contained in the title list created for the recorded program series may be the same, namely, they may be the same main title. Such a title list is useless since it makes it difficult for the users, who try to select a program for viewing, to identify the programs in the program series.

### DISCLOSURE OF THE INVENTION

It is therefore an object of the present invention to provide a program list generating apparatus that facilitates the user's selection of a program that the user desires to view, even in the case of recording a program series.

The above object of the present invention is fulfilled by a program list generating apparatus for generating a program list, comprising: an acquiring unit operable to acquire a first title being a title of a first program; an extracting unit operable to extract a first difference from the first title, the first difference being a portion of the first title and not being contained in a second title being a title of a second program; and a program list generating unit operable to generate the program list based on the first difference extracted by the extracting unit.

With the above-stated construction, the generated program list includes the first difference that is a portion of the first title and is not contained in the second title. This enables the user to recognize the first title when referring to the program list. More specifically, suppose that the first and second programs belong to a same program series, and the first and second titles have a same main title and a different sub title. Even in such a case, the user can easily select a program that the user desires to view since the program list shows only the sub titles.

In the above-described program list generating apparatus, the acquiring unit may acquire the first and second titles from a program guide which shows information of a plurality of programs, and the extracting unit extracts the first difference by removing, from the first title, one or more characters that are contained in both the first and second titles.

With the above-stated construction, the user does not need to enter the title since the program list generating apparatus acquire the first and second titles from the program guide. Furthermore, the program list generating apparatus extracts the first difference with reliability since it removes a same character sequence contained in the first and second titles in common, from the first title.

In the above-described program list generating apparatus, the extracting unit may further extract a character sequence having a predetermined length from the first difference, and the program list generating unit generates the program list, which contains the character sequence having the predetermined length extracted by the extracting unit.

With the above-stated construction, the program list generating apparatus generates a unique program list that does not depend on, for example, a format set in a recording medium.

In the above-described program list generating apparatus, the extracting unit may prestore information indicating a number of bytes that corresponds to the predetermined length, and extracts, from the first difference, the character sequence having the number of bytes indicated by the information.

With the above-stated construction, the program list generating apparatus generates a program list that displays program titles having a predetermined length that is uniquely set for the program list generating apparatus, without depending on, for example, a format set in a recording medium.

In the above-described program list generating apparatus, if a character sequence constituting the first difference is shorter than the character sequence having the number of bytes, the extracting unit combines part or all of the one or more characters with part or all of the character sequence constituting the first difference to generate a combination character sequence having the number of bytes indicated by the information, and the program list generating unit generates the program list, which contains the combination character sequence generated by the extracting unit.

With the above-stated construction, even if the first difference is shorter than the predetermined length, the maximum number of characters can be extracted for display. This makes the program list more convenient for the user who selects a program to view referring to the program list.

The above-described program list generating apparatus may further comprise: a receiving unit operable to receive the first program; and a recording unit operable to record the received first program into a recording medium in conformity with a first recording format, wherein the extracting unit extracts, from the first difference, the character sequence having the predetermined length, which corresponds to the first recording format.

In the above-described program list generating apparatus, the recording unit may select the first recording format among a plurality of recording formats that respectively correspond to a plurality of types of recording mediums, and records the first program into the recording medium in conformity with the first recording format, and the extracting unit prestores information that indicates a correspondence between the plurality of recording formats and one or more lengths, and extracts, from the first difference, a character sequence having a length that corresponds to the first recording format.

With the above-stated construction, the program list generating apparatus generates a program list that conforms to the recording format, without depending on, for example, a format set in a recording medium.

The above-described program list generating apparatus may be connected to a monitor, wherein the character sequence, which is extracted from the first difference by the extracting unit, conforms to a display format of the program list on the monitor.

The above-described program list generating apparatus may further comprise: a display format receiving-unit operable to receive a display format of the program list on the monitor, wherein the extracting unit prestores information that indicates a correspondence between the plurality of display formats and one or more lengths for each of a plurality of display formats, and extracts, from the first difference, a character sequence having a length that corresponds to the display format received by the display format receiving unit.

With the above-stated construction, the program list generating apparatus generates a program list in accordance with the customization of the GUI design, without depending on, for example, a format set in a recording medium. Since the GUI design is selected by the user, this construction allows the program list generating apparatus to generate a program list that suits the user's taste.

The above-described program list generating apparatus may be connected to a monitor, wherein the character sequence extracted by the extracting unit conforms to an attribute of the monitor.

The above-described program list generating apparatus may further comprise: a monitor information acquiring unit operable to acquire monitor information indicating a resolution of the monitor, from the monitor, wherein

the extracting unit prestores information that indicates a correspondence between a plurality of resolutions and one or more lengths, and extracts, from the first difference, a character sequence having a length that corresponds to the resolution indicated by the monitor information acquired by the monitor information acquiring unit.

With the above-stated construction, the program list generating apparatus generates a program list in accordance with an attribute of the monitor, such as the resolution. This allows the program list generating apparatus to generate a program list that is easy for the user to watch.

The above-described program list generating apparatus may further comprise: a receiving unit operable to receive the first and second programs; and a recording unit operable to record the received first and second programs, wherein the extracting unit extracts the first difference from the first title, and extracts a second difference from the second title, the first and second differences being respectively portions of the first and second titles and being different from each other, and the program list generated by the program list generating unit contains the first and second differences.

With the above-stated construction, the program list generating apparatus generates a title list composed of titles that are different from each other by extracting differences from the first and second titles of the first and second programs. This enables the user to identify the first and second programs by referring to the title list.

The above-described program list generating apparatus may further comprise: a program list outputting unit operable to output the generated program list to an external monitor connected to the program list generating apparatus; a program selection receiving unit operable to receive a selection of a program that is made by a user viewing the program list displayed on the monitor; and a program reproduction unit operable to output reproduction of the program selected by the user, to the monitor.

With the above-stated construction, the program list generating apparatus displays the title list on the monitor, enabling the user to select a program that the user desires to reproduce, by referring to the displayed title list. When the first and second programs belong to a same program series, and the first and second titles have a same character sequence, the remaining portion of each title (difference) after removing the same character sequence is displayed in the title list. This enables the user to identify the first and second programs by referring to the title list.

### BRIEF DESCRIPTION OF THE DRAWINGS

FIG. 1 is a block diagram showing the construction of a program recording apparatus 100.

FIG. 2 shows the data structure of a preset table 120.

FIG. 3 shows the data structure of an EPG 130, an example displayed on the monitor 110a.

FIG. 4 shows the data structure of a title list 140, an example displayed on the monitor 110a.

FIG. 5 is a flowchart of the overall operation of the program recording apparatus 100.

FIG. 6 is a flowchart of a detail of the preset recording process performed by the program recording apparatus 100.

FIG. 7 is a flowchart of the title list generating process performed by the program recording apparatus 100, continued to FIG. 8.

FIG. 8 is a flowchart of the title list generating process performed by the program recording apparatus 100, continued from FIG. 7.

FIG. 9 is a block diagram showing the construction of the program recording apparatus 200.

FIG. 10 shows the data structure of a preset table 250.

FIG. 11 shows the data structure of an EPG 260, an example displayed on the monitor 240a.

FIG. 12 shows the data structure of a table 270.

FIG. 13A shows a title list 281, an example displayed on a monitor.

FIG. 13B shows a title list 282, an example displayed on a monitor.

FIG. 13C shows a title list 283, an example displayed on a monitor.

FIG. 14 is a flowchart of the title list generating process performed by the program recording apparatus 200, continued to FIG. 15.

FIG. 15 is a flowchart of the title list generating process performed by the program recording apparatus 200, continued from FIG. 14.

FIG. 16 is a flowchart showing the operation of a program recording apparatus, which is a modification of the program recording apparatus 200, in generating a title list in accordance with the customization of the GUI design.

FIG. 17A shows an example of a title list 291, a GUI design for child, displayed on a monitor.

FIG. 17B shows an example of a title list 292, a GUI design for adult, displayed on a monitor.

FIG. 18 is a block diagram showing the construction of the program recording apparatus 300.

FIG. 19 shows the data structure of the EPG 320.

FIG. 20 shows the data structure of the EPG 330.

FIG. 21A shows the data structure of a recommendation list 340 of new programs, an example displayed on the monitor 310a.

FIG. 21B shows the data structure of a recommendation list 350 of rerun programs, an example displayed on the monitor 310a.

FIG. 22 is a flowchart showing the operation of the program recording apparatus 300.

FIG. 23A shows the data structure of the EPG 410, an example displayed on the monitor 310a.

FIG. 23B shows the data structure of the EPG 420, an example displayed on the monitor 310a.

FIG. 24A shows the data structure of a recommendation list 430, an example displayed on a monitor.

FIG. 24B shows the data structure of a recommendation list 440, an example displayed on a monitor.

FIG. 25 is a flowchart showing the operation of a program recording apparatus in generating the recommendation lists 430 and 440.

FIG. 26 shows the data structure of a table 500.

FIG. 27 is a flowchart showing the operation of a modification of the program recording apparatus 300.

### BEST MODE FOR CARRYING OUT THE INVENTION

### Embodiment 1

1. Construction

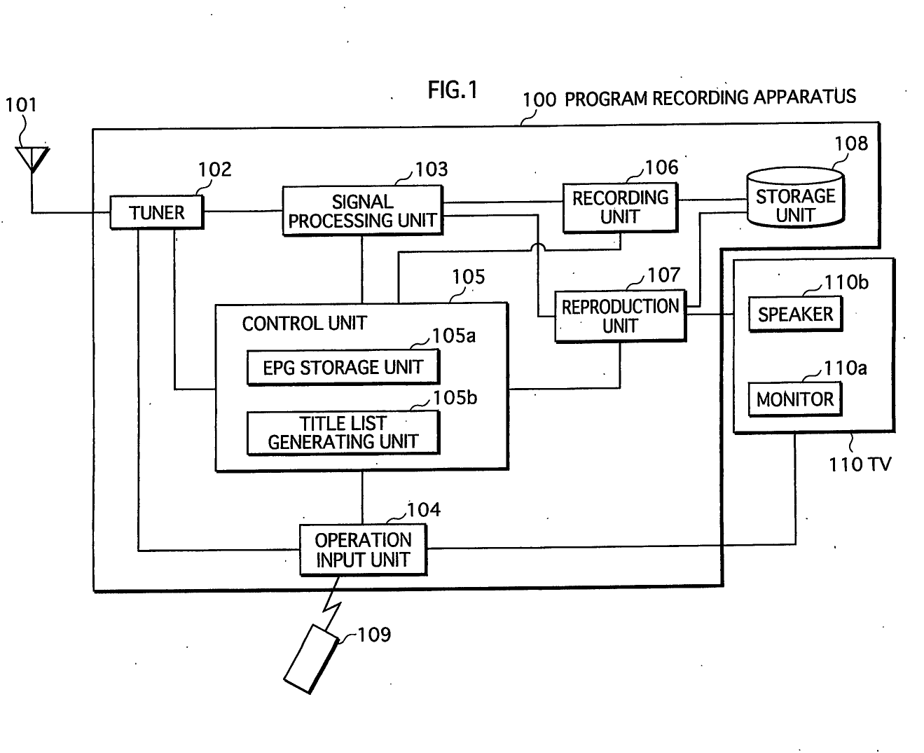

FIG. 1 is a block diagram showing the construction of a program recording apparatus 100. As shown in FIG. 1, the program recording apparatus 100 includes an antenna 101, a tuner 102, a signal processing unit 103, an operation input unit 104, a control unit 105, a recording unit 106, a reproduction unit 107, a storage unit 108, and a remote controller 109. The control unit 105 includes an EPG storage unit 105a and a title list generating unit 105b. The reproduction unit 107 is connected to an external TV 110 via a cable. The TV 110 includes a monitor 110a and a speaker 110b.

The program recording apparatus 100 is more specifically a computer including a microprocessor, a ROM, a RAM, a hard disk drive unit and the like. It is supposed here that the program recording apparatus 100 is a hard disk recorder for receiving broadcast programs that are broadcast on digital broadcast waves, recording the received broadcast programs onto an embedded hard disk, and reproducing the recorded broadcast programs.

(1) Tuner 102

The tuner 102 receives, via the antenna 101, digital broadcast waves that are broadcast by broadcasting stations, and extracts a digital signal of a specified channel from the received digital broadcast waves. The tuner 102 outputs the extracted digital signal to the signal processing unit 103. It should be noted here that the specification of the channel is received from either the operation input unit 104 or the control unit 105.

(2) Signal Processing Unit 103

The signal processing unit 103 receives a digital signal from the tuner 102, and generates broadcast data by decoding the received digital signal. The signal processing unit 103 divides the broadcast data into program data and EPG data. Upon receiving a display instruction from the control unit 105, the signal processing unit 103 outputs the program data to the reproduction unit 107, and upon receiving a recording instruction, the signal processing unit 103 outputs the program data to the recording unit 106. The signal processing unit 103 also writes EPG into the EPG storage unit 105a.

(3) Operation Input Unit 104

The operation input unit 104, which includes a light receiving unit for receiving an infrared signal, receives an infrared signal from the remote controller 109, generates an input signal corresponding to the received infrared signal, and outputs the generated input signal to the control unit 105.

More specifically, the infrared signal received by the operation input unit 104 is a display request, a reproduction request, a recording request, a recording preset request or the like.

The display request is a request to receive a digital signal, extract therefrom a signal of a specified channel, decodes and amplifies the extracted signal, and output the resultant signal to the TV 110. The operation input unit 104 generates an input signal corresponding to the display request, and outputs the generated input signal to the control unit 105.

The reproduction request is a request to read a MPEG stream from the storage unit 108, decode the MPEG stream, and output the decoded MPEG stream to the TV 110. The operation input unit 104 generates an input signal corresponding to the reproduction request, and outputs the generated input signal to the control unit 105.

The recording request is a request to receive broadcast data, decode the broadcast data, re-encode the decoded broadcast data into a MPEG stream, and write the MPEG stream into the storage unit 108. The operation input unit 104 generates an input signal corresponding to the recording request, and outputs the generated input signal to the control unit 105.

The recording preset request is composed of a broadcast day or a broadcast pattern, a broadcast start time, a broadcast end time, and a channel number. The recording preset request is a request to, on the broadcast day or a day specified by the broadcast pattern, receive and record broadcast data of the channel number into the storage unit 108, starting at the broadcast start time and ending at the broadcast end time. The broadcast pattern is any of “every Sunday”, “every Monday”, “every Tuesday”, “every Wednesday”, “every Thursday”, “every Friday”, “every Saturday”, and “Monday through Friday”. The operation input unit 104 generates an input signal corresponding to the recording preset request, and outputs the generated input signal to the control unit 105.

The operation input unit 104 also receives a preset information display request, an EPG display request, or a title list display request, generates an input signal corresponding to the received request, and outputs the generated input signal to the control unit 105.

Upon receiving a channel number from the remote controller 109, such as channel 1, channel 2, or channel 3, the operation input unit 104 outputs the received channel number to the tuner 102.

The operation input unit 104, outputs data of an image that corresponds to the infrared signal received from the remote controller 109, to the monitor 110a of the TV 110. The image is, for example, an image to indicate an audio volume level visually on the monitor 110a.

(4) Control Unit 105

The control unit 105 includes a microprocessor, a ROM, a RAM and the like, and achieves the following functions as the microprocessor executes a computer program that is recorded on the ROM or the RAM.

(a) Process According to Input Signal

The control unit 105 receives an input signal from the operation input unit 104, judges the type of the received input signal, and performs a process according to the input signal.

When the received input signal is the display request, the control unit 105 outputs an instruction to the signal processing unit 103 to output broadcast data to the reproduction unit 107.

When the received input signal is the reproduction request, the control unit 105 outputs a reproduction instruction to the reproduction unit 107.

When the received input signal is the recording request, the control unit 105 outputs an instruction to the signal processing unit 103 to output broadcast data to the recording unit 106.

When the received input signal is the EPG display request, the control unit 105 reads the EPG from the EPG storage unit 105a, and outputs it to the reproduction unit 107. When the received input signal is the title list display request, the control unit 105 reads the title list from the storage unit 108, and outputs it to the reproduction unit 107.

When the received input signal is the recording preset request, the control unit 105 generates preset information, and writes the generated preset information into a preset table that is stored inside the control unit 105. The preset information and the preset table will be described in detail later.

(b) Process Regarding with Recording Presetting

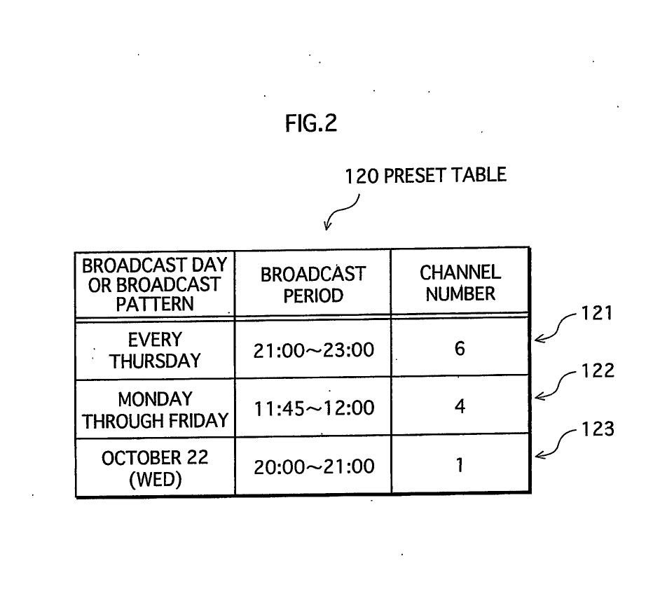

FIG. 2 shows the data structure of a preset table 120, an example of the preset table. As shown in FIG. 2, the preset table 120 includes preset information 121, 122, and 123. Each preset information is composed of a broadcast day or a broadcast pattern, a broadcast period, and a channel number.

The preset information 121 is composed of a broadcast pattern “every Thursday”, a broadcast period “21:00-23:00”, and a channel number “6”. This indicates recording of a program of channel 6 that is broadcast from 9 p.m. to 11 p.m. on every Thursday.

The preset information 122 is composed of a broadcast pattern “Monday through Friday”, a broadcast period “11:45-12:00”, and a channel number “4”. This indicates recording of a program of channel 4 that is broadcast from 11.45 a.m. to noon Monday through Friday.

The preset information 123 is composed of a broadcast day “October 22 (Wed)”, a broadcast period “20:00-21:00”, and a channel number “1”. This indicates recording of a program of channel 1 that is broadcast from 8 p.m. to 9 p.m. on October 22, Wednesday.

It should be noted here that hereinafter, the term “program recording presetting” refers to a recording presetting which is done using a piece of preset information that includes a broadcast day, namely a piece of preset information such as preset information 123 that specifies a program, and that the term “series recording presetting” refers to a recording presetting which is done using a piece of preset information including a broadcast pattern, namely a piece of preset information such as preset information 121 and 122 that corresponds to a plurality of programs.

The control unit 105 refers to a latest EPG stored in the EPG storage unit 105a to judge for each piece of preset information written in the preset table 120 whether the contents of the preset information matches information written in the latest EPG. For example, the broadcast period written in the preset information may be different from the broadcast period written in the latest EPG when a sports relay broadcast is extended, when an urgent news is broadcast, or when a first or final episode of a drama series is broadcast longer than normal. In such a case, 105 replaces the broadcast period written in the preset information with the broadcast period written in the latest EPG. The control unit 105 may perform the above-described judgment and replacement each time a latest EPG is acquired.

After the above-described operation, the control unit 105 instructs the tuner 102 to select a channel based on the preset information, and instructs the signal processing unit 103 to output program data to the recording unit 106.

(c) EPG Storage Unit 105a

The control unit 105 is provided with the EPG storage unit 105a for storing EPG.

When a latest EPG is output from the signal processing unit 103, the EPG storage unit 105a overwrites the EPG it has stored so far with the latest EPG.

The EPG includes information such as broadcast periods and titles for each program. In the present embodiment, it is presumed that the EPG includes not only information regarding programs to be broadcast after the date and time at which the EPG was transmitted, but information regarding programs that were broadcast during the past week.

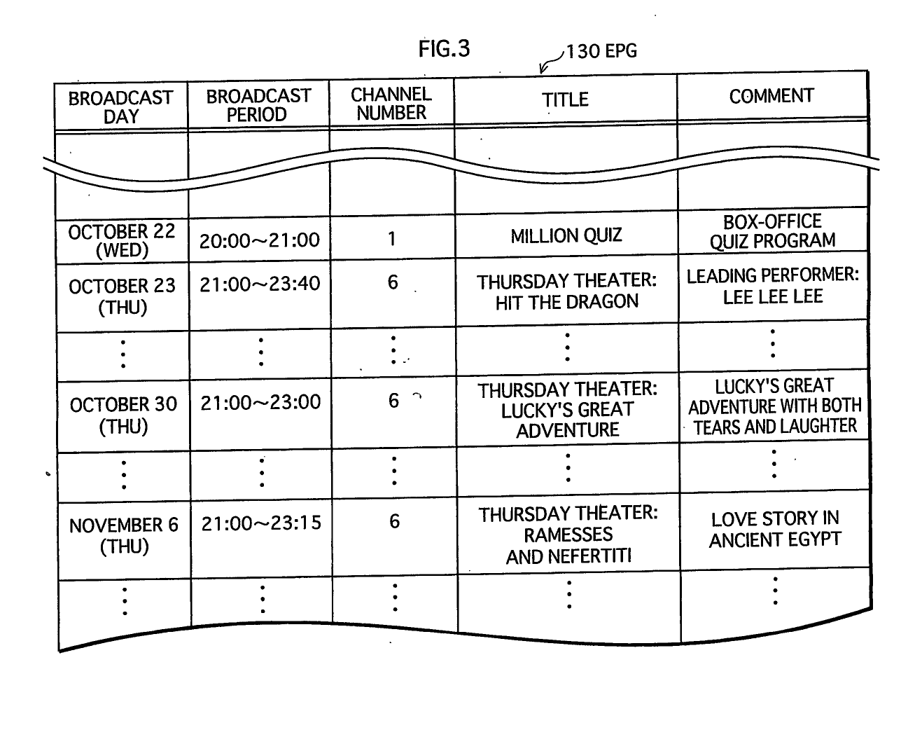

FIG. 3 shows the data structure of an EPG 130, an example of EPG. The EPG 130 includes a plurality of pieces of program information each of which includes a broadcast day, a broadcast period, a channel number, a title, and a comment.

The EPG 130 is displayed on the monitor 110a of the TV 110 via the reproduction unit 107, and is used when the user selects a program he/she desires to view, record, or preset for recording.

The EPG 130 is also used when the title list generating unit 105b generates title information for a program having been recorded.

The title list generating unit 105b and the title information will be described in detail later.

The display format of the EPG on the monitor 110a is not limited to the one shown in FIG. 3, but may be a different format in which, for example, the information is displayed for each broadcast day or each channel number.

(d) Title List Generating Unit 105b

The control unit 105 further includes the title list generating unit 105b.

When a program is recorded by the recording unit 106, the title list generating unit 105b generates title information of the recorded program as follows, and stores the generated title information by adding it to the title list.

Here, explanation will be given using a specific example case in which the recording unit 106, based on the preset information 121, records a program “Thursday Theater: Hit The Dragon” broadcast on channel 6 from 9 p.m. to 11.40 p.m. on October 23, Thursday, and the title list generating unit 105b generates the title information of the program.

After the recording unit 106 completes recording the program, the title list generating unit 105b acquires the recording date/time and the channel number. The title list generating unit 105b then refers to the preset table 120 stored in the control unit 105 and detects the piece of preset information, out of a plurality of pieces of preset information provided in the preset table 120, that was used as a basis for recording the program. In this example, the control unit 105 detects that the preset information 121 was used as a basis for recording the program. The title list generating unit 105b further judges whether the program was recorded based on the program recording presetting or the series recording presetting. In this example, the title list generating unit 105b judges that the program was recorded based on the series recording presetting since the preset information 121 includes a broadcast pattern.

The title list generating unit 105b acquires the title of the program, “Thursday Theater: Hit The Dragon”, from the EPG 130 stored in the EPG storage unit 105a.

The title list generating unit 105b further acquires, from the EPG 130, a title of a program that was broadcast on the day before for the same period and on the same channel as the present program. The title list generating unit 105b compares the titles of the programs broadcast on the day and on the day before, and judges whether they contain a same character sequence at the beginning of the titles. When the title list generating unit 105b judges positively, the title list generating unit 105b generates a piece of title information that includes the broadcast day, the broadcast start time, the channel number, and the remaining portion of the title which is obtained by removing the common character sequence from the title of the present program. In this example, the title list generating unit 105b judges that there is no character sequence contained in the beginning of both titles. In such a case, the title list generating unit 105b discards the title of the program broadcast on the day before, and acquires, from the EPG 130, a title of a program that is to be broadcast on the day after for the same period and on the same channel as the present program.

The title list generating unit 105b compares the titles of the programs broadcast on the day and on the day after, and judges whether they contain a same character sequence at the beginning of the titles. When the title list generating unit 105b judges positively, the title list generating unit 105b generates a piece of title information that includes the broadcast day, the broadcast start time, the channel number, and the remaining portion of the title which is obtained by removing the common character sequence from the title of the present program. In this example, the title list generating unit 105b judges that there is no character sequence contained in the beginning of both titles. In such a case, the title list generating unit 105b discards the title of the program broadcast on the day after, and acquires, from the EPG 130, a title of a program that was broadcast a week before for the same period and on the same channel as the present program.

The title list generating unit 105b compares the titles of the programs broadcast on the day and a week before, and judges whether they contain a same character sequence at the beginning of the titles. When the title list generating unit 105b judges positively, the title list generating unit 105b generates a piece of title information that includes the broadcast day, the broadcast start time, the channel number, and the remaining portion of the title which is obtained by removing the common character sequence from the title of the present program. In this example, the title list generating unit 105b judges that there is no character sequence contained in the beginning of both titles. In such a case, the title list generating unit 105b discards the title of the program broadcast a week before, and acquires, from the EPG 130, a title of a program that is to be broadcast a week after for the same period and on the same channel as the present program, which is in this example “Thursday Theater: Lucky's Great Adventure”.

The title list generating unit 105b compares the titles: “Thursday Theater: Hit The Dragon” and “Thursday Theater: Lucky's Great Adventure”. The two titles have a same character sequence “Thursday Theater:” at the beginning of the titles. When this happens, in this case, the title list generating unit 105b removes the common character sequence “Thursday Theater:” from the title of the present program, “Thursday Theater: Hit The Dragon”. The title list generating unit 105b generates a piece of title information that includes the broadcast day “October 23”, the broadcast start time “21:00”, the channel number “6”, and “Hit The Dragon” that is the remaining portion of the title.

If the title list generating unit 105b judges that there is no common character sequence between the present title and the title of any of the programs broadcast the day before, the day after, a week before, and a week after, the title list generating unit 105b extracts a character sequence of a predetermined number of bytes from the beginning of the title, “Thursday Theater: Hit The Dragon”. In this example, it is presumed that the title list generating unit 105b extracts a character sequence “Thursday Theater:” as having the predetermined number of bytes. The title list generating unit 105b then generates a piece of title information that includes the broadcast day “October 23”, the broadcast start time “21:00”, the channel number “6”, and the extracted character sequence “Thursday Theater:”.

If the title list generating unit 105b cannot acquire, from the EPG, the titles of the programs broadcast the day before, the day after, a week before, and a week after, the title list generating unit 105b performs as described above as in the above case where it cannot find a common character sequence between the present title and the title of any of these programs. When 0 byte remains after the common character sequence is removed from the title of the present program, the title list generating unit 105b extracts the common character sequence.

The title list generating unit 105b outputs the generated piece of title information to the storage unit 108 via the recording unit 106.

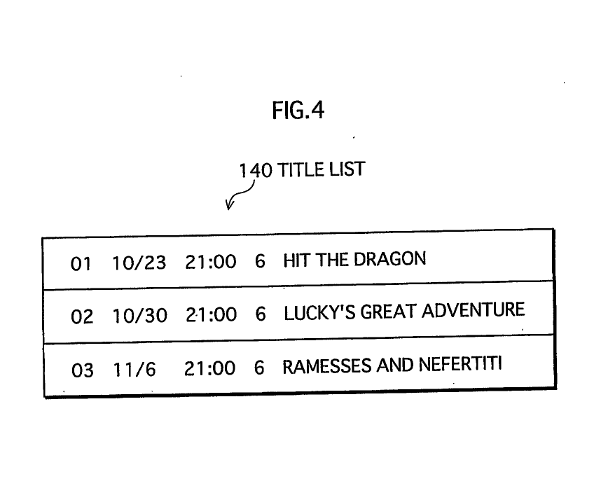

FIG. 4 shows the data structure of a title list 140, which is an example of the title list. The title list 140 corresponds to a program recorded based on the preset information 121 (FIG. 2) by the series recording presetting.

The EPG 130 shown in FIG. 3 includes “Thursday Theater: Hit The Dragon”, “Thursday Theater: Lucky's Great Adventure”, and “Thursday Theater: Ramesses And Nefertiti” as the program titles, while the title list 140 shown in FIG. 4 includes, as the corresponding titles, “Hit The Dragon”, “Lucky's Great Adventure”, and “Ramesses And Nefertiti” which were generated by removing the common character sequence “Thursday Theater:” from the originals.

The 140 is displayed on the monitor 110a via the reproduction unit 107, and is used when the user selects a program he/she desires to view, among the programs having been recorded.

Although the present embodiment describes a case where a program is recorded based on the preset table, the title list generating unit 105b in reality also generates a piece of title information when a program is recorded not based on the preset table. In this case, the title list generating unit 105b does not refer to the preset table.

(5) Recording Unit 106

The recording unit 106, upon receiving program data from the signal processing unit 103, re-encodes the received program data to generate a MGEP stream, and writes the generated MGEP stream into the storage unit 108. Also, upon receiving a piece of title information from the title list generating unit 105b, the recording unit 106 outputs the received piece of title information to the storage unit 108.

More specifically, the recording unit 106 includes a recording control unit, a program data buffer, a separating unit, a video buffer, an audio buffer, a video encoder, an audio encoder, and a combining unit.

The recording control unit receives the program data decoded by the signal processing unit 103, and stores the received program data into the program data buffer temporarily.

The separating unit receives the program data from the program data buffer, and separates the program data into a video signal and an audio signal. The separating unit outputs the video signal to the video buffer, and outputs the audio signal to the audio buffer.

The video buffer temporarily stores the video signal received from the separating unit. The video buffer outputs the video signal to the video encoder in accordance with the processing speed of the video encoder.

The audio buffer temporarily stores the audio signal received from the separating unit. The audio buffer outputs the audio signal to the audio encoder in accordance with the processing speed of the audio encoder.

The video encoder receives the video signal from the video buffer, and encodes the received video signal in conformity with MPEG standards to generate a video stream. The video encoder outputs the generated video stream to the combining unit.

The audio encoder receives the audio signal from the audio buffer, and encodes the received audio signal in conformity with MPEG standards to generate an audio stream. The audio encoder outputs the generated audio stream to the combining unit.

The combining unit receives video and audio streams respectively from the video and audio encoders, multiplexes the received video and audio streams in conformity with MPEG standards to generate a MPEG stream, and outputs the generated MPEG stream to the storage unit 108.

(6) Reproduction Unit 107

The reproduction unit 107, upon receiving the program data from the signal processing unit 103, outputs the received program data to the monitor 110a and the speaker 110b. Also, upon receiving a reproduction instruction from the control unit 105, the reproduction unit 107 receives a MPEG stream from the storage unit 108, decodes the received MPEG stream to generate program data, and outputs the generated program data to the monitor 110a and the speaker 110b. Furthermore, the reproduction unit 107 outputs the EPG or title list to the monitor 110a.

More specifically, the reproduction unit 107 includes a reproduction control unit, a separating unit, a video decoder, an audio decoder, a video buffer, an audio buffer, a video signal amplifying unit, and an audio signal amplifying unit.

The reproduction control unit receives the program data from the signal processing unit 103, and outputs the received program data to the separating unit. The reproduction control unit also receives the MPEG stream and the title list from the storage unit 108, and outputs the received MPEG stream and title list to the separating unit. The reproduction control unit also receives the EPG from the control unit 105, and outputs the received EPG to the separating unit.

The separating unit receives the program data from the reproduction control unit, separates the received program data into a video signal and an audio signal, outputs the video signal and the audio signal to the video signal amplifying unit and the audio signal amplifying unit, respectively. Also, the separating unit receives the MPEG stream from the reproduction control unit, separates the received MPEG stream into a video stream and an audio stream, outputs the video stream and the audio stream to the video decoder and the audio decoder, respectively. The separating unit also receives the EPG and the title list from the reproduction control unit, and outputs the received EPG and title list to the video signal amplifying unit.

The video decoder receives the video stream from the separating unit, decodes the received video stream to generate a video signal, and outputs the generated video signal to the video buffer.

The audio decoder receives the audio stream from the separating unit, decodes the received audio stream to generate an audio signal, and outputs the generated audio signal to the audio buffer.

The video buffer temporarily stores the video signal having been generated by the video decoder. The video buffer outputs the video signal to the monitor 110a.

The audio buffer temporarily stores the audio signal having been generated by the audio decoder. The audio buffer outputs the audio signal to the speaker 110b.

The video signal amplifying unit receives the video signal, EPG, and title list from the separating unit, amplifies the received video signal, EPG, and title list, and outputs them to the monitor 110a.

The audio signal amplifying unit receives the audio signal from the separating unit, amplifies the received audio signal, and outputs the amplified audio signal to the speaker 110b.

(7) Storage Unit 108

The storage unit 108 is a hard disk drive unit.

The storage unit 108 receives the MPEG stream from the recording unit 106, and writes the received MPEG stream into a hard disk in conformity with a HD recording format. The MPEG stream the storage unit 108 receives from the recording unit 106 is a MPEG stream that was re-encoded by the recording unit 106. The recorded MPEG streams are managed as files. For the management, file names are assigned to the files based on the recording dates/times and channel numbers. The file names may be changed by the user freely. The storage unit 108 further stores a title list. Upon receiving a piece of title information from the recording unit 106, the storage unit 108 adds it to the title list.

Upon receiving a reproduction request from the reproduction unit 107, the storage unit 108 reads out a MPEG stream from the hard disk in accordance with the received request, and outputs the read-out MPEG stream to the reproduction control unit of the reproduction unit 107. Also, upon receiving a title list display request from the reproduction unit 107, the storage unit 108 reads out the title list from the hard disk, and outputs the read-out title list to the reproduction control unit of the reproduction unit 107.

(8) Remote Controller 109

The remote controller 109 is provided with channel buttons, a record button, a fast-forward button, a rewind button, a playback button, a stop button, a pause button or the like on an operation surface thereof.

After the user depresses a button provided on the operation surface thereof, the remote controller 109 generates an infrared signal that corresponds to the depressed button, and transmits the generated infrared signal to the operation input unit 104.

(9) Monitor 110a

The monitor 110a displays images during the display process and the reproduction process.

(10) Speaker 110b

The speaker 110b outputs voices/sounds during the display process and the reproduction process.

2. Operation

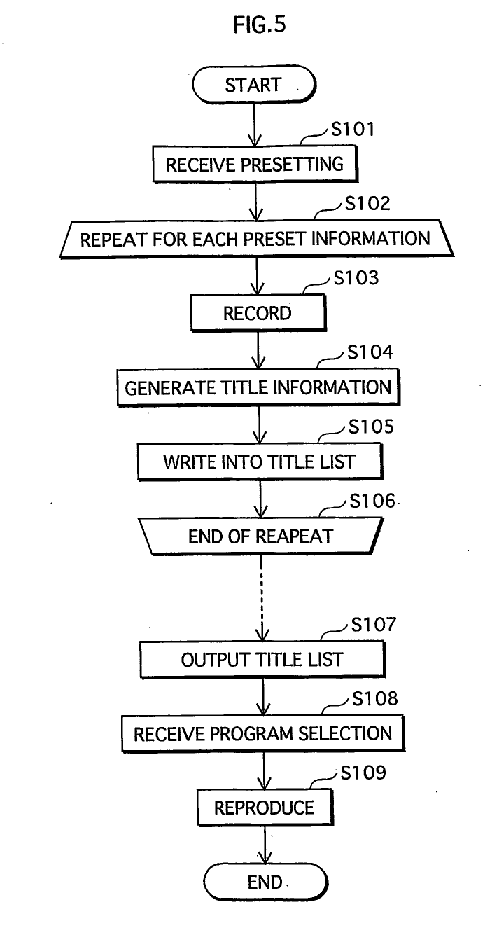

Here, the operation of the program recording apparatus 100 in recording a program based on a recording presetting and generating a title list for the recorded program will be explained with reference to the flowcharts shown in FIGS. 5-8.

(1) Overall Operation

FIG. 5 is a flowchart of the overall operation of the program recording apparatus 100.

The program recording apparatus 100 receives a program or series recording presetting (step S101). The program recording apparatus 100 generates a piece of preset information, and writes the generated piece of preset information into the preset table. The program recording apparatus 100 repeats the steps S102 through S106 for each piece of preset information contained in the preset table.

The program recording apparatus 100 records a program based on a piece of preset information (step S103), and generates a piece of title information of the recorded program (step S104). The program recording apparatus 100 writes the generated piece of title information into the title list (step S105). Later, when it receives a request from the user, the program recording apparatus 100 outputs the title list (step S107), and receives a selection of a program (step S108). The program recording apparatus 100 reproduces the selected program (step S109).

(2) Recording Operation

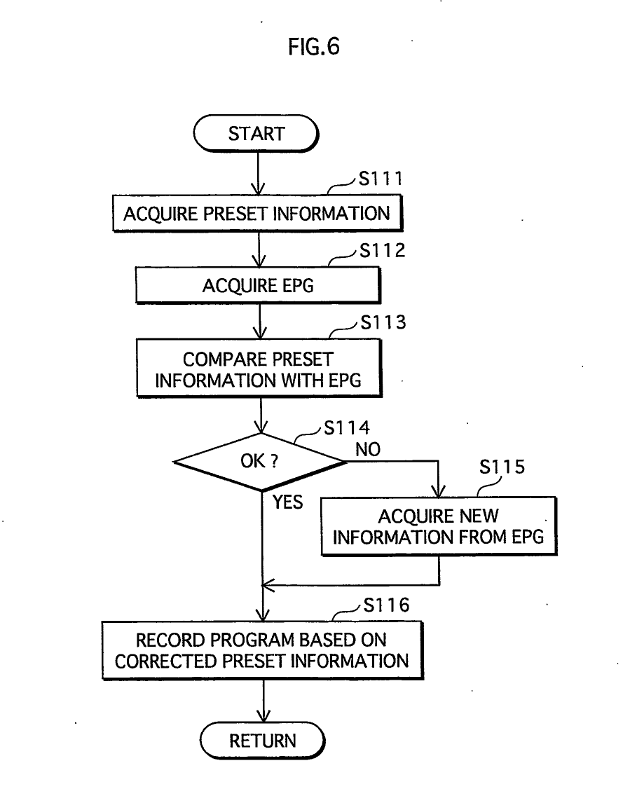

FIG. 6 is a flowchart of a detail of the recording process performed in step S103 of FIG. 5. The control unit 105 continues to manage the current time using a clock, and monitors the preset table at regular intervals. The control unit 105 proceeds with step S111 when the current time reaches a time that precedes a recording start time by a predetermined period.

The control unit 105 acquires a piece of preset information from the preset table (step S111). The control unit 105 then reads out a latest EPG from the EPG storage unit 105a that is stored inside the control unit 105 (step S112). The control unit 105 refers to the latest EPG acquired in step S112 to judge whether the contents of the acquired piece of preset information matches information written in the latest EPG (step S113). This judgment is made because, for example, the broadcast period written in the preset information may be different from the broadcast period written in the latest EPG when a sports relay broadcast is extended, or when an urgent news is broadcast.

When it is judged that the contents of the acquired piece of preset information does not match information written in the latest EPG (“NO” in step S114), the control unit 105 acquires a new piece of information from the EPG (step S115), and corrects the contents of the acquired piece of preset information based on the newly acquired piece of information. The program recording apparatus 100 records a program based on the corrected piece of preset information (step S116).

More specifically, in step S116, the control unit 105, based on the corrected piece of preset information, notifies the tuner 102 of a channel number to be selected, and outputs a recording instruction to the signal processing unit 103. The tuner 102 selects the notified channel, and outputs a digital signal to the signal processing unit 103. The signal processing unit 103, upon receiving the recording instruction from the control unit 105, decodes the digital signal to generate broadcast data, and outputs program data, which is contained in the broadcast data, to the recording unit 106. The recording unit 106, upon receiving the program data, re-encodes the received program data to generate a MPEG stream, and writes the generated MPEG stream into the storage unit 108.

(3) Operation of Generating Title Information

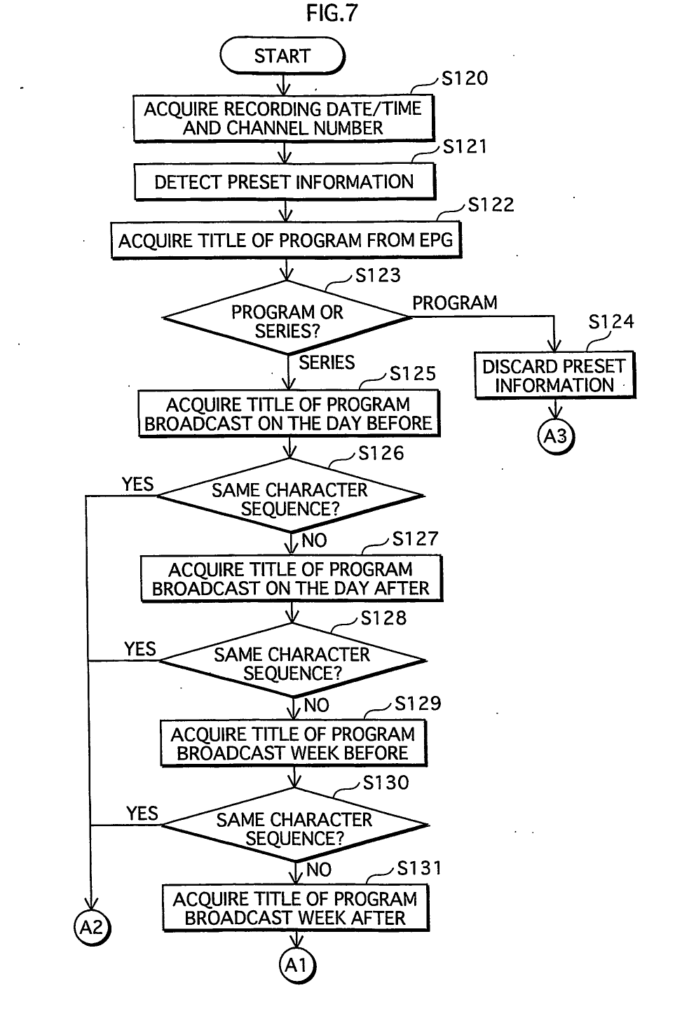

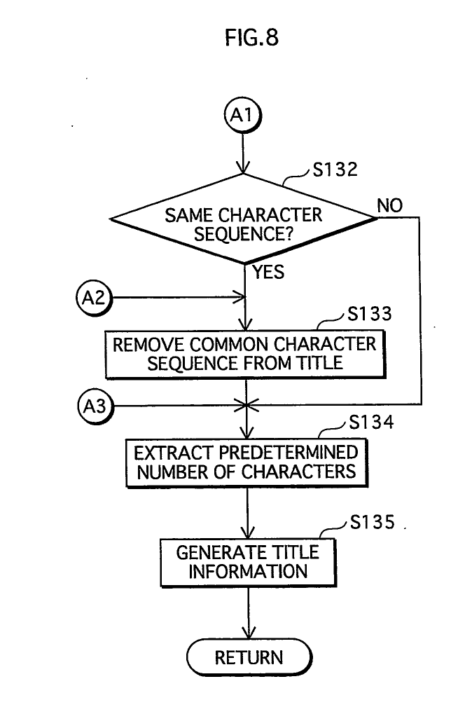

FIGS. 7 and 8 are flowcharts of a detail of the title information generating process performed in step S104 of FIG. 5.

The title list generating unit 105b acquires the recording date/time and the channel number of the program recorded in step S116 of FIG. 6 (step S120). The title list generating unit 105b then refers to the preset table 120 stored in the control unit 105 and detects the piece of preset information that was used as a basis for recording the program (step S121). The title list generating unit 105b acquires the title of the program from the latest EPG stored in the EPG storage unit 105a, based on the recording date/time and the channel number acquired in step S120 (step S122).

The title list generating unit 105b refers to the piece of preset information detected in step S121 to judge whether the program was recorded by the program recording presetting or the series recording presetting (step S123).

If it is judged that the program was recorded by the program recording presetting (“PROGRAM” in step S123), the title list generating unit 105b discards the piece of preset information corresponding to the program from the preset table (step S124), and goes to step S134.

If it is judged that the program was recorded by the series recording presetting (“SERIES” in step S123), the title list generating unit 105b acquires, from the EPG 130, a title of a program that was broadcast on the day before for the same period and on the same channel as the present program (step S125).

The title list generating unit 105b compares the title acquired in step S122 with the title acquired in step S125 and judges whether they contain a same character sequence at the beginning of the titles. When the title list generating unit 105b judges positively (“YES” in step S126), the control goes to step S133. When the title list generating unit 105b judges negatively (“NO” in step S126), the title list generating unit 105b acquires a title of a program that is to be broadcast on the day after for the same period and on the same channel as the present program (step S127).

The title list generating unit 105b compares the title acquired in step S122 with the title acquired in step S127 and judges whether they contain a same character sequence at the beginning of the titles. When the title list generating unit 105b judges positively (“YES” in step S128), the control goes to step S133. When the title list generating unit 105b judges negatively (“NO” in step S128), the title list generating unit 105b acquires, from the EPG, a title of a program that was broadcast a week before for the same period and on the same channel as the present program (step S129).

The title list generating unit 105b compares the title acquired in step S122 with the title acquired in step S129 and judges whether they contain a same character sequence at the beginning of the titles. When the title list generating unit 105b judges positively (“YES” in step S130), the control goes to step S133. When the title list generating unit 105b judges negatively (“NO” in step S130), the title list generating unit 105b acquires, from the EPG, a title of a program that is to be broadcast a week after for the same period and on the same channel as the present program (step S131).

The title list generating unit 105b compares the title acquired in step S122 with the title acquired in step S131 and judges whether they contain a same character sequence at the beginning of the titles. When the title list generating unit 105b judges negatively (“NO” in step S132), the control goes to step S134. When the title list generating unit 105b judges positively (“YES” in step S132), the title list generating unit 105b removes the common character sequence from the title acquired in step S122 (step S133).

The title list generating unit 105b then extracts a sequence of a predetermined number of characters from the beginning of the title acquired in step S122 or the title after the common character sequence was removed therefrom in step S133 (step S134).

The title list generating unit 105b then generates a piece of title information that includes the broadcast date/time, the channel number, and the predetermined number of characters extracted in step S134 (step S135).

<Modification>

Here, a program recording apparatus 200, a modification of the program recording apparatus 100 disclosed in Embodiment 1, will be explained with reference to the drawings. The program recording apparatus 200, as is the case with the program recording apparatus 100, records programs and generates a title list of the recorded programs.

1. Construction

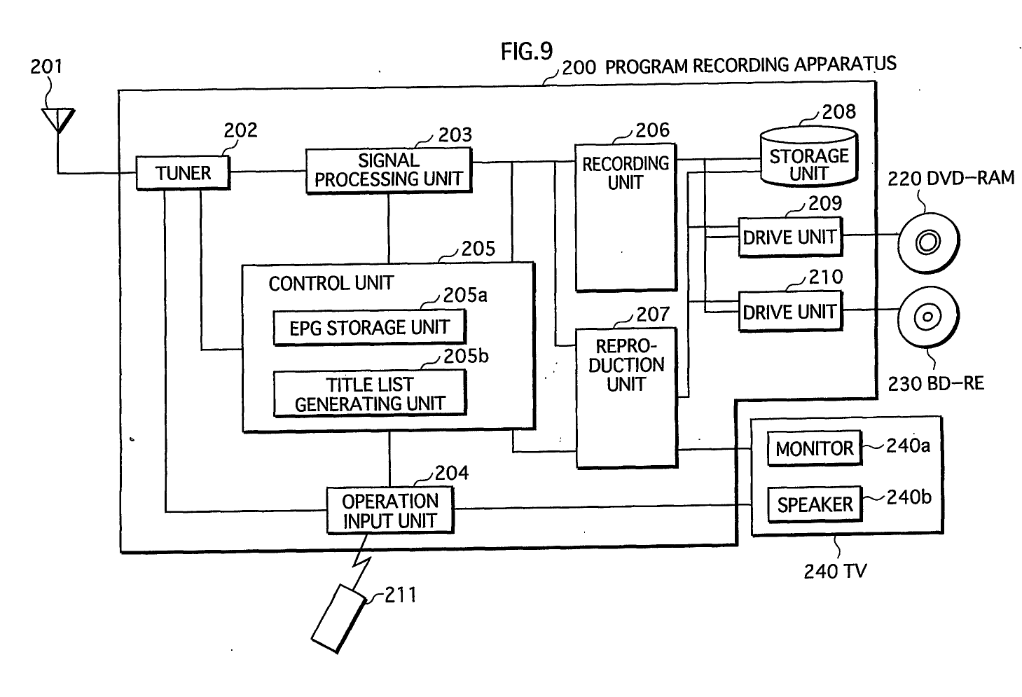

FIG. 9 is a block diagram showing the construction of the program recording apparatus 200. As shown in FIG. 9, the program recording apparatus 200 includes an antenna 201, a tuner 202, a signal processing unit 203, an operation input unit 204, a control unit 205, a recording unit 206, a reproduction unit 207, a storage unit 208, a drive unit 209, and a drive unit 210. The control unit 205 includes an EPG storage unit 205a and a title list generating unit 205b. The reproduction unit 207 is connected to an external TV 240. The TV 240 includes a monitor 240a and a speaker 240b.

(1) Difference from Program Recording Apparatus 100

The program recording apparatus 200 differs from the program recording apparatus 100 in that it additionally includes the drive unit 209 and the drive unit 210.

The drive unit 209 is a DVD-RAM drive unit and, as shown in FIG. 9, is attached with a DVD-RAM 220. The drive unit 209 receives a MPEG stream from the recording unit 206 and writes it into the 220. Also, upon receiving a request from the reproduction unit 207, the drive unit 209 reads a MPEG stream from the 220, and outputs the read MPEG stream to the reproduction unit 207. The drive unit 209 supports two types of recording formats: the DVD-video format; and the DVD-original format. The DVD-original format provides more functions than the DVD-video format, and is highly usable, enabling video, audio, menu or the like of the recorded contents to be edited, for example.

The drive unit 210 is a BD (Blu-ray Disc) drive unit and, as shown in FIG. 9, is attached with a BD-RE 230. The BD-RE 230 is a rewritable Blu-ray Disc. The drive unit 210 writes a MPEG stream, which is received from the recording unit 206, into the 230 in conformity with the BD recording format. Also, upon receiving a request from the reproduction unit 207, the drive unit 210 reads a MPEG stream from the 230, and outputs the read MPEG stream to the reproduction unit 207. The drive unit 209 and the drive unit 210 may share a tray for holding a disc.

The program recording apparatus 100 is embedded with a hard disk drive unit, and records programs on a hard disk. In contrast, the program recording apparatus 200 is provided with the DVD drive and the BD drive, as well as the hard disk drive unit. Accordingly, the program recording apparatus 200 can records programs onto three types of recording mediums: hard disk, DVD-RAM, and BD-RE.

The antenna 201, tuner 202, signal processing unit 203, operation input unit 204, storage unit 208, remote controller 211 of the program recording apparatus 200 and the TV 240 have the same constructions and functions as the antenna 101, tuner 102, signal processing unit 103, operation input unit 104, storage unit 108, remote controller 109 of the program recording apparatus 100 and the TV 110, and their detailed explanation is omitted here.

(2) Control Unit 205

As is the case with the control unit 105, the control unit 105 includes a microprocessor, a ROM, a RAM and the like, and controls the program recording apparatus 200 as a whole as the microprocessor executes a computer program.

(a) Process Regarding with Recording Presetting

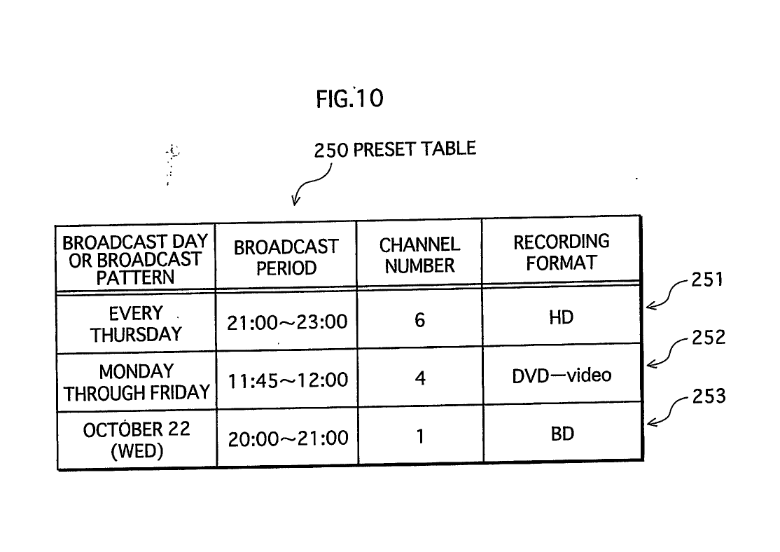

FIG. 10 shows the data structure of a preset table 250. As shown in FIG. 10, the preset table 250 includes preset information 251, 252, and 253. Each preset information is composed of a broadcast day or a broadcast pattern, a broadcast period, a channel number, and a recording format. The preset table 250 additionally has the column of the recording format, compared with the preset table 130 shown in FIG. 2. Each piece of preset information is input to the control unit 205 via the operation input unit 204 as the 211 receives user operations.

The preset information 251 is composed of a broadcast pattern “every Thursday”, a broadcast period “21:00-23:00”, a channel number “6”, and a recording format “HD”. This indicates recording, into the storage unit 208 in conformity with the HD recording format, of a program of channel 6 that is broadcast from 9 p.m. to 11 p.m. on every Thursday.

The preset information 252 is composed of a broadcast pattern “Monday through Friday”, a broadcast period “11:45-12:00”, a channel number “4”, and a recording format “DVD-video”. This indicates recording, into the 220 in conformity with the DVD-video recording format, of a program of channel 4 that is broadcast from 11.45 a.m. to noon Monday through Friday.

The preset information 253 is composed of a broadcast day “October 22 (Wed)”, a broadcast period “20:00-21:00”, a channel number “1”, and a recording format “BD”. This indicates recording, into the 230 in conformity with the BD recording format, of a program of channel 1 that is broadcast from 8 p.m. to 9 p.m. on October 22, Wednesday.

As is the case with the control unit 105, the control unit 205 instructs the tuner 202 to select a channel based on the preset information stored in the 250, and instructs the signal processing unit 203 to output program data to the recording unit 206.

(b) EPG Storage Unit 205a

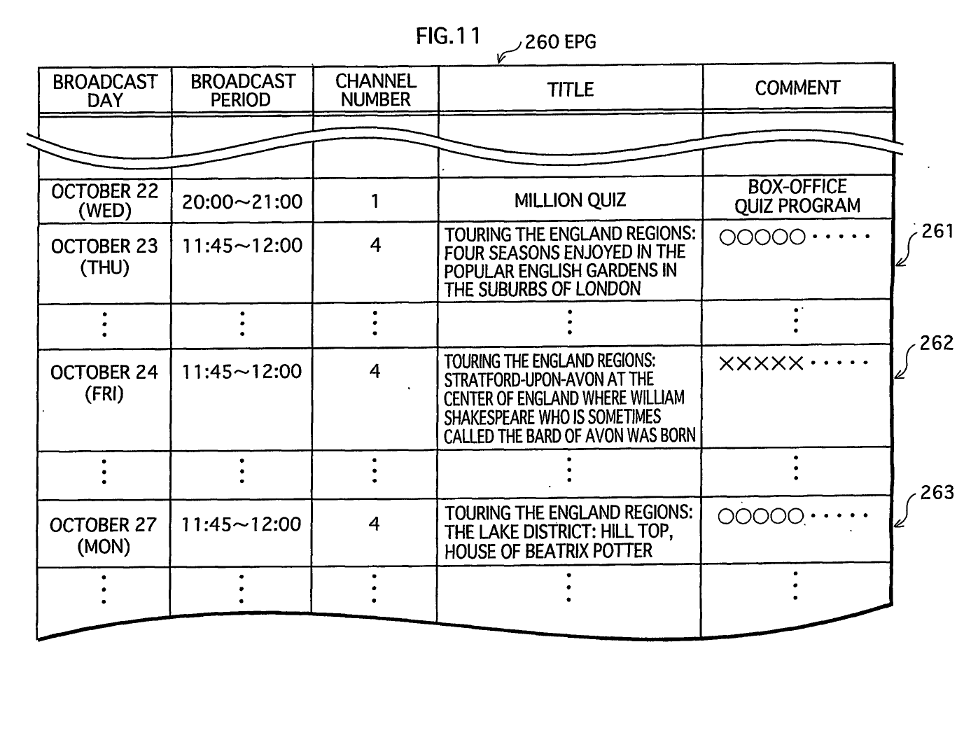

As is the case with the EPG storage unit 105a, the EPG storage unit 205a is a storage area for storing the EPG, and stores the latest EPG received from the signal processing unit 203. It is presumed here that the EPG storage unit 205a stores an EPG 260 shown in FIG. 11, as the latest EPG.

(c) Title List Generating Unit 205b

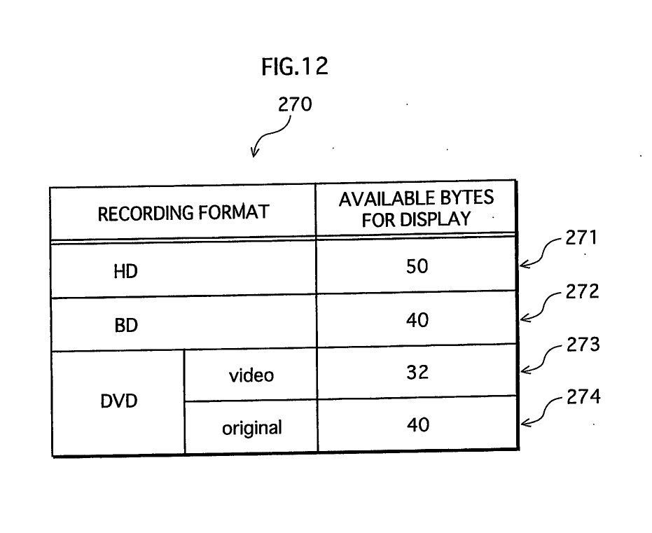

The title list generating unit 205b stores therein a table 270 shown in FIG. 12 in advance. The table 270 includes columns of “recording format” and “available bytes for display”. The number of bytes written in the “available bytes for display” column are each a maximum number of bytes that can be used for displaying a title in the title list on screen, which depends on the recording format in which the program of the title is recorded.

More specifically, information 271 indicates that 50 bytes are available for the HD recording format, information 272 indicates that 40 bytes are available for the BD recording format, information 273 indicates that 32 bytes are available for the DVD-video recording format, and information 274 indicates that 40 bytes are available for the DVD-original recording format.

The title list generating unit 205b generates each piece of title information in accordance with the recording format in which the program of the title is recorded. More specifically, the title list generating unit 205b generates a title list that is composed of pieces of title information which each include a title having bytes less than the maximum number of bytes that is determined in advance for each recording format. The title list generating unit 205b writes the generated title list into each recording medium via the recording unit 206.

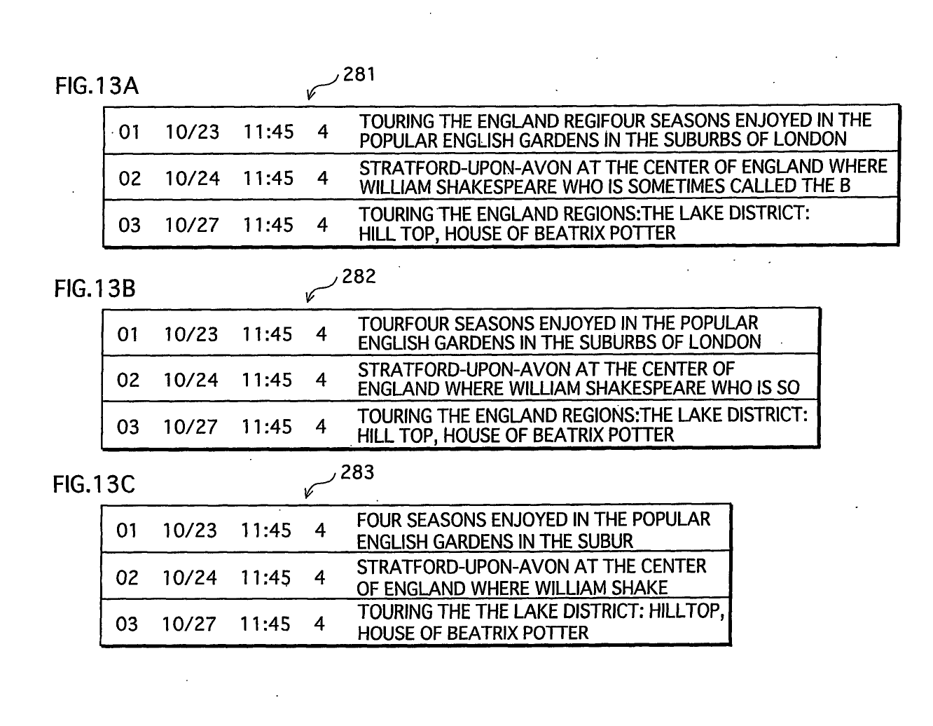

FIGS. 13A, 13B, and 13C show specific examples of title lists generated by the title list generating unit 205b. These title lists are generated when a program series “Touring The England Regions” shown in the EPG 260 (FIG. 11) is recorded.

A title list 281 shown in FIG. 13A is generated when the program series “Touring The England Regions” is recorded in conformity with the HD recording format. Since the maximum number of bytes for the HD recording format is 50 bytes, each title contained in the title list 281 is equal to or less than 50 bytes.

A title list 282 shown in FIG. 13B is generated when the program series “Touring The England Regions” is recorded in conformity with the DVD-original recording format or the BD recording format. Since the maximum number of bytes for the these recording formats is 40 bytes, each title contained in the title list 282 is equal to or less than 40 bytes.

A title list 283 shown in FIG. 13C is generated when the program series “Touring The England Regions” is recorded in conformity with the DVD-video recording format. Since the maximum number of bytes for the DVD-video recording format is 32 bytes, each title contained in the title list 283 is equal to or less than 32 bytes.

How to extract 32 bytes, 40 bytes, 50 bytes or the like from the title shown in the EPG 260 will be detailed in the following description of the operation.

2. Operation

Description of the overall operation of the program recording apparatus 200 is omitted here and no flowchart is provided since it is the same as that of the program recording apparatus 100 shown in FIG. 5.

Also, description of the recording process of the program recording apparatus 200 is omitted here and no flowchart is provided since it is the same as that of the program recording apparatus 100 shown in FIG. 6.

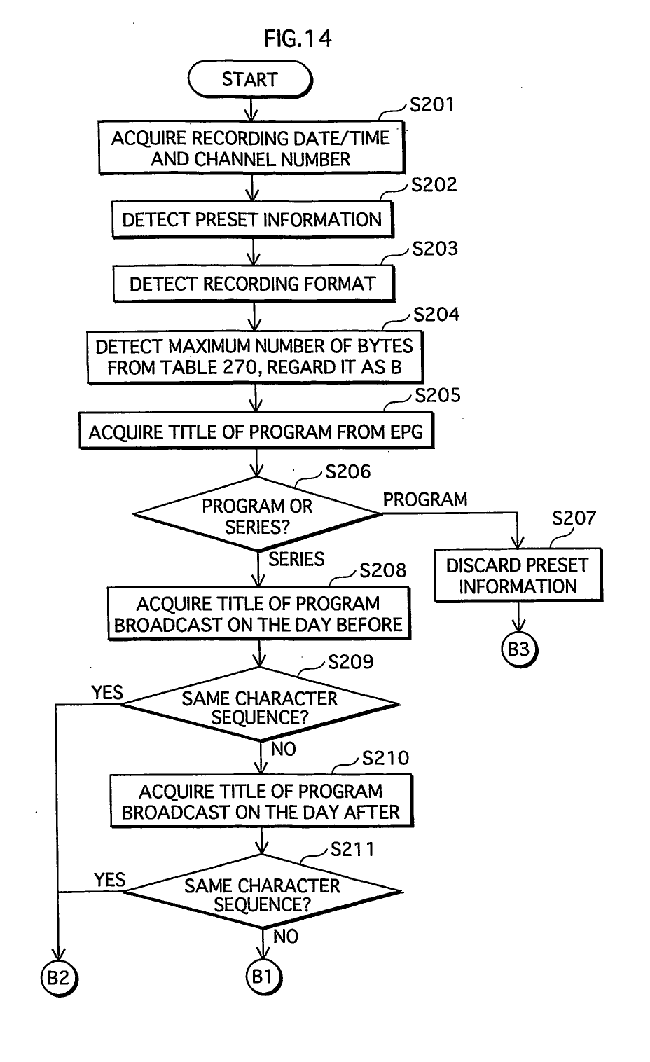

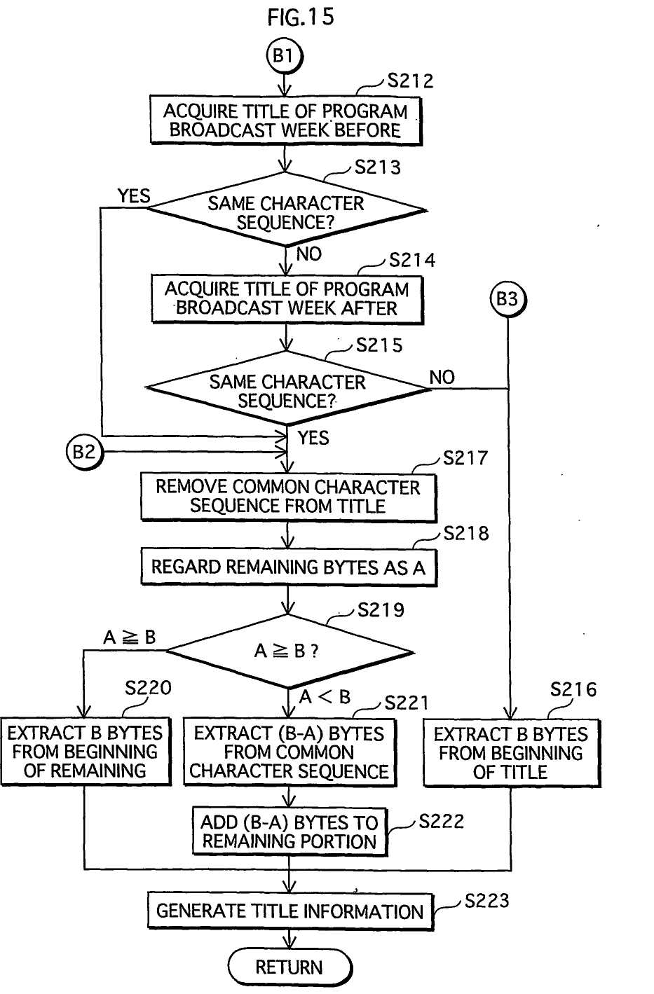

Here, the title list generating process of the program recording apparatus 200, which is different from that of the program recording apparatus 100, will be described with reference to the flowcharts shown in FIGS. 14 and 15. The description provided here is a detail of step S104 shown in FIG. 5.

The title list generating unit 205b acquires the recording date/time and the channel number of a recorded program (step S201). The title list generating unit 205b then refers to the preset table and detects the piece of preset information that was used as a basis for recording the program (step S202). The title list generating unit 205b refers to the detected piece of preset information to detect the recording format in which the program was recorded (step S203). The title list generating unit 205b refers to the table 270 to detect the maximum number of bytes that corresponds to the recording format detected in step S203, and regards the detected maximum number of bytes as “B” (step S204).

The title list generating unit 205b then acquires the title of the program from the latest EPG stored in the EPG storage unit 205a, based on the recording date/time and the channel number acquired in step S201 (step S205).

The title list generating unit 205b refers to the piece of preset information detected in step S202 to judge whether the program was recorded by the program recording presetting or the series recording presetting (step S206).

If it is judged that the program was recorded by the program recording presetting (“PROGRAM” in step S206), the title list generating unit 205b discards the piece of preset information corresponding to the program from the preset table (step S207), and goes to step S216.

If it is judged that the program was recorded by the series recording presetting (“SERIES” in step S206), the title list generating unit 205b acquires, from the EPG, a title of a program that was broadcast on the day before for the same period and on the same channel as the present program (step S208).

The title list generating unit 205b compares the title acquired in step S205 with the title acquired in step S208 and judges whether they contain a same character sequence at the beginning of the titles. When the title list generating unit 205b judges positively (“YES” in step S209), the control goes to step S217. When the title list generating unit 205b judges negatively (“NO” in step S209), the title list generating unit 205b acquires a title of a program that is to be broadcast on the day after for the same period and on the same channel as the present program (step S210).

The title list generating unit 205b compares the title acquired in step S205 with the title acquired in step S210 and judges whether they contain a same character sequence at the beginning of the titles. When the title list generating unit 205b judges positively (“YES” in step S211), the control goes to step S217. When the title list generating unit 205b judges negatively (“NO” in step S211), the title list generating unit 205b acquires, from the EPG, a title of a program that was broadcast a week before for the same period and on the same channel as the present program (step S212).

The title list generating unit 205b compares the title acquired in step S205 with the title acquired in step S212 and judges whether they contain a same character sequence at the beginning of the titles. When the title list generating unit 205b judges positively (“YES” in step S213), the control goes to step S217. When the title list generating unit 205b judges negatively (“NO” in step S213), the title list generating unit 205b acquires, from the EPG, a title of a program that is to be broadcast a week after for the same period and on the same channel as the present program (step S214).

The title list generating unit 205b compares the title acquired in step S205 with the title acquired in step S214 and judges whether they contain a same character sequence at the beginning of the titles. When the title list generating unit 205b judges negatively (“NO” in step S215), the title list generating unit 205b extracts B bytes from the beginning of the title acquired in step 205 (step S216), and goes to step S223. When the title list generating unit 205b judges positively (“YES” in step S215), the title list generating unit 205b removes the common character sequence from the title acquired in step S205 (step S217), and regards the number of the remaining bytes of the title (difference between the title and the common character sequence) as “A” (step S218).

The title list generating unit 205b then compares A and B. If A≧B, namely if the number of bytes of the difference between the title and the common character sequence is equal to or larger than the maximum number of bytes (“A≧B” in step S219), the title list generating unit 205b extracts B bytes from the beginning of the title after the common character sequence was removed from the title (step S220), and goes to step S223.

If A<B, namely if the number of bytes of the difference between the title and the common character sequence is smaller than the maximum number of bytes (“A<B” in step S219), the title list generating unit 205b extracts (B−A) bytes from the common character sequence (step S221), then adds the extracted (B−A) bytes to the remaining portion of the title (step S222), and goes to step S223. If the number of bytes of the common character sequence is equal to or smaller than the (B−A) bytes, the title list generating unit 205b extracts all of the common character sequence in step S221.

The title list generating unit 205b generates a piece of title information that includes the broadcast date/time, the channel number, and a title having B or smaller bytes (step S223).

Here, explanation will be given using a specific example.

Suppose that the program series “Touring The England Regions” is recorded in conformity with the HD recording format. The maximum number of bytes that can be used for displaying a title in the title list is 50 bytes in the case of the HD recording format (B=50 in step S204).

According to the program information 261, the title of the “Touring The England Regions” broadcast on October 23 (Thursday) is “Touring The England Regions: Four Seasons Enjoyed In The Popular English Gardens In The Suburbs Of London”, which is 52 bytes long. According to the program information 262, the title of the “Touring The England Regions” broadcast on October 24 (Friday) is “Touring The England Regions:Stratford-Upon-Avon At The Center Of England Where William Shakespeare Who Is Sometimes Called The Bard of Avon Was Born”, which is 74 bytes long. According to the program information 263, the title of the “Touring The England Regions” broadcast on October 27 (Monday) is “Touring The England Regions:The Lake District: Hill Top, House Of Beatrix Potter”, which is 40 bytes long.

These titles have a character sequence “Touring The England Regions:”, which is 14 bytes long, in common.

The title list generating unit 205b detects by calculation that the difference between the title indicated by the program information 261 and the common character sequence is 38 bytes (A=38 in step S218), extracts “Touring The England Regi” having 12 bytes (B−A=12 in step S221) from the common character sequence (step S221), then adds, to “Touring The England Regi”, the remaining portion “Four Seasons Enjoyed In The Popular English Gardens In The Suburbs Of London” having 38 bytes to generate a title “Touring The England RegiFour Seasons Enjoyed In The Popular English Gardens In The Suburbs Of London” having 50 bytes.

The title list generating unit 205b also detects by calculation that the difference between the title indicated by the program information 262 and the common character sequence is 60 bytes (A=60 in step S218), and extracts 50 bytes “Stratford-Upon-Avon At The Center Of England Where William Shakespeare Who Is Sometimes Called The B” from the beginning of the remaining portion of the title.

The title list generating unit 205b also detects by calculation that the difference between the title indicated by the program information 263 and the common character sequence is 26 bytes (A=26 in step S218), and extracts all the 14 bytes of the common character sequence “Touring The England Regions:”, then adds the extracted “Touring The England Regions:” to the remaining portion “The Lake District: Hill Top, House Of Beatrix Potter” to generate a title “Touring The England Regions:The Lake District: Hill Top, House Of Beatrix Potter”.

In the above-described manner, the title list generating unit 205b generates the title list 281 shown in FIG. 13A.

<Other Modifications>

As stated earlier, the present invention relates to a program recording apparatus for recording programs and generating a title list of the recorded programs.

The present invention is not limited to the program recording apparatus 100 or the program recording apparatus 200 described above as specific examples, but may be modified as follows.

(1) In the above-described embodiment, the program recording apparatus 100 generates a title having a predetermined number of bytes, and the program recording apparatus 200 generates a title having bytes less than the maximum number of bytes that is determined in advance for each recording format. However, the length of the title (the number of bytes) to be displayed in the title list may be determined in accordance with the customized GUI design.

For example, the program recording apparatus may store a GUI customization program. The GUI customization program is a computer program that receives a GUI design selected by the user, and achieves the selected GUI design. Suppose, as an example, that the user can select either of “Child GUI” and “Adult GUI” as the GUI design.

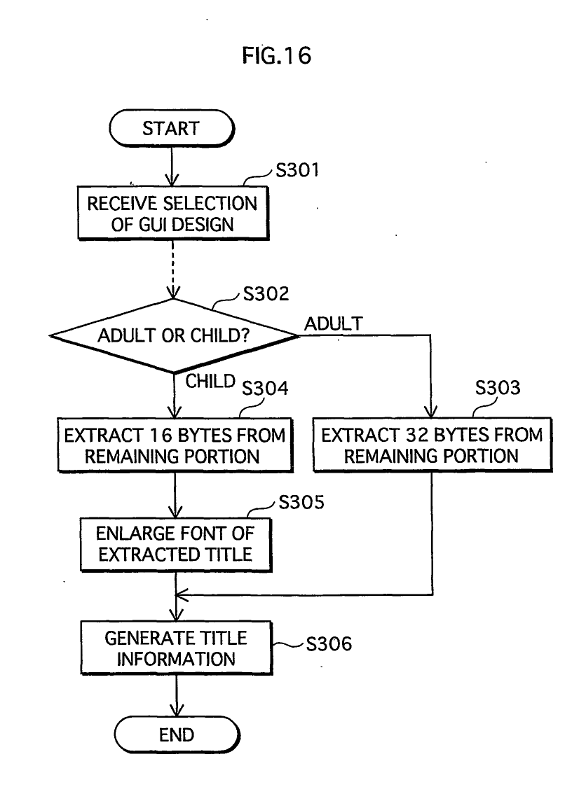

FIG. 16 is a flowchart showing part of the operation by the program recording apparatus in executing the GUI customization program. The operation described here is an operation in which the program recording apparatus records a program series, and generates title information of the recorded program.

The program recording apparatus receives a selection of GUI design (step S301). If the selected GUI design is “Adult GUI” (“ADULT” in step S302), the program recording apparatus deletes a common character sequence from a title of the program series, and extracts 32 bytes from the remaining portion of the title (step S303), and goes to step S306.

If the selected GUI design is “Child GUI” (“CHILD” in step S302), the program recording apparatus deletes a common character sequence from a title of the program series, and extracts 16 bytes from the remaining portion of the title (step S304). The program recording apparatus then enlarges the font of the extracted title in width and height (step S305). That is to say, after this enlargement, the font of “Child GUI” is larger than “Adult GUI” in width and height. The program recording apparatus then generates a piece of title information that includes the broadcast date/time, the channel number, and the extracted title (step S306).

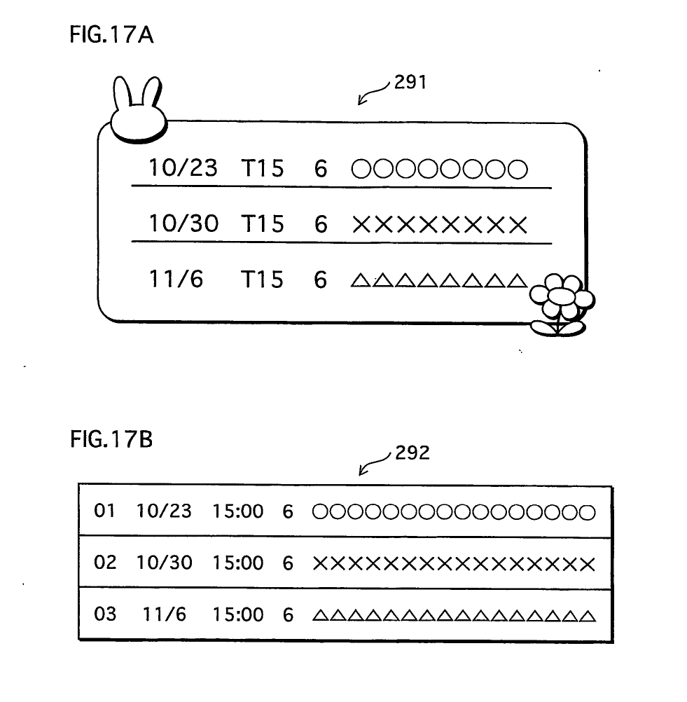

A title list 291 shown in FIG. 17A is generated when “Child GUI” is selected. A title list 292 shown in FIG. 17B is generated when “Adult GUI” is selected. The title list 291 has larger font size and fewer characters than the title list 292.

It should be noted here that each type of GUI design may be different from each other not only in width and height of the font, but in the font type, and that a plurality of types of GUI designs may be used, not limited to two as in “Child GUI” and “Adult GUI”.

If a GUI customization program is stored in a DVD-RAM or BD-RE, programs may be recorded in the DVD-RAM or BD-RE. Then, when the title list is generated for the programs recorded in the DVD-RAM or BD-RE, the program recording apparatus may read the GUI customization program from the DVD-RAM or BD-RE and execute it, and determine the number of bytes of the title to be displayed in the title list, in accordance with the GUI design selected by the user.

(2) The program recording apparatus may determine the number of bytes of the title to be displayed in the title list, in accordance with the attribute of the TV to which the apparatus is connected.

More specifically, the program recording apparatus stores, in advance, the attributes of the TV and the number of bytes in correspondence with each other.

For example, the digital TV is correlated with 32 bytes, and the analog TV is correlated with 16 bytes. The program recording apparatus, when it is connected to a TV, acquires, from the TV, identification information for identifying the attribute of the TV. The program recording apparatus then extracts 32 bytes from each title shown in the EPG if the identification information indicates that the TV is a digital TV, and extracts 16 bytes from each title shown in the EPG if the identification information indicates that the TV is an analog TV.

The program recording apparatus may store not only information of the number of bytes, but information of the font size or font type in correspondence with the attributes of TV, and generate title information in accordance with the stored information.

(3) In the above-described embodiment or modifications, the program recording apparatus extracts a predetermined number of bytes from a title shown in the EPG if the title has more bytes than the maximum number of bytes that can be used for displaying the title in the title list, and discards the rest of the title. However, the present invention is applicable to a case where the rest of the title is not discarded, but is stored in a specific storage area.

In this case, upon receiving a request from the user, the program recording apparatus restores the original title of the program by combining information of a predetermined number of bytes, which is included in the title information, with information stored in the specific storage area. This enables the user to edit or process the title list.

(4) In the above-described modification, the maximum number of bytes (the table 270 shown in FIG. 12), which the program recording apparatus holds for each recording medium, may not necessarily match, or may exceed, the number of bytes that is permitted by the format of the recording medium itself.

For example, according to the table 270, each title contained in the title information for the programs recorded in BD-RE can have 40 bytes at the maximum. On the other hand, the format of the BD-RE permits only 24 bytes to be used as the title in the title information. In this case, the program recording apparatus extracts 40 bytes from the title shown in the EPG, and divides the extracted 40 bytes into 24 bytes, which is permitted by the format of the BD-RE, and the remaining 16 bytes.

The program recording apparatus writes the 24 bytes into the specific storage area in the BD-RE, and writes the remaining 16 bytes into a different area such as the user storage area in the BD-RE.

When reading the title list from the BD-RE and outputting it onto the monitor, the program recording apparatus may read the 24 bytes and 16 bytes respectively, combine them together, and display the resultant 40 bytes on the monitor.

### Embodiment 2

The following describes a program recording apparatus 300 in Embodiment 2 of the present invention, with reference to the drawings.

1. Construction

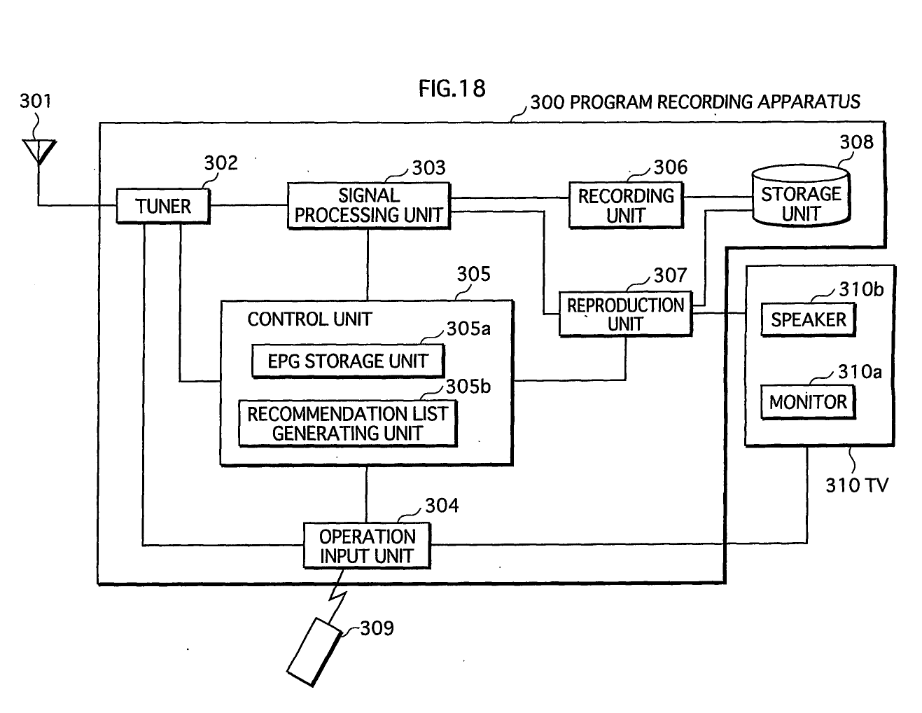

FIG. 18 is a block diagram showing the construction of the program recording apparatus 300. As shown in FIG. 18, the program recording apparatus 300 includes an antenna 301, a tuner 302, a signal processing unit 303, an operation input unit 304, a control unit 305, a recording unit 306, a reproduction unit 307, a storage unit 308, and a remote controller 309. The control unit 305 includes an EPG storage unit 305a and a recommendation list generating unit 305b. The reproduction unit 307 is connected to an external TV 310. The TV 310 includes a monitor 310a and a speaker 310b.

The program recording apparatus 300 is more specifically a computer including a microprocessor, a ROM, a RAM, a hard disk drive unit and the like. It is supposed here that the program recording apparatus 300 is a hard disk recorder for receiving broadcast programs that are broadcast on digital broadcast waves, recording the received broadcast programs onto an embedded hard disk, and reproducing the recorded broadcast programs.

The antenna 301, tuner 302, signal processing unit 303, operation input unit 304, recording unit 306, reproduction unit 307, storage unit 308, and remote controller 309 of the program recording apparatus 300 have the same functions as the antenna 101, tuner 102, signal processing unit 103, operation input unit 104, recording unit 106, reproduction unit 107, storage unit 108, and remote controller 109 of the program recording apparatus 100, and their detailed explanation is omitted here, and the following description focuses on differences from the program recording apparatus 100.

The program recording apparatus 300 acquires the EPG from the received broadcast data, retrieves new programs from the EPG, and records each broadcast of the new programs starting with their first broadcast. The program recording apparatus 300 generates a title list for new programs and rerun programs having been recorded, shows the generated title list, and receives a selection from the user. In the present embodiment, it is presumed that the EPG includes information regarding programs to be broadcast after the date and time at which the EPG was transmitted.

Recording New Programs

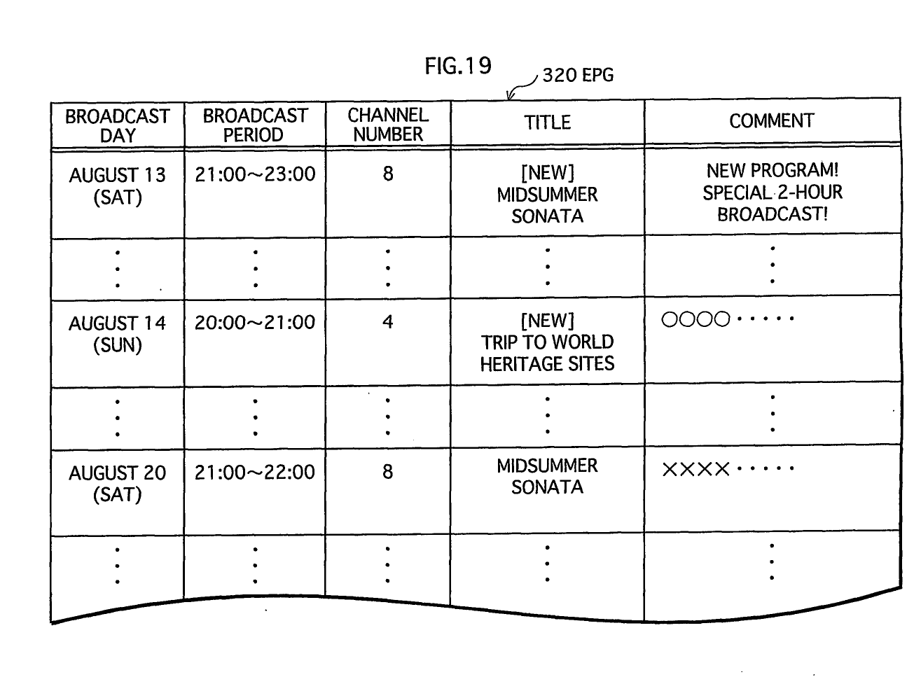

The control unit 305 performs the following on a regular basis or each time a latest EPG is stored in the EPG storage unit 305a. It is presumed here that the EPG 320, which is shown in FIG. 19, is stored as the latest EPG in the EPG storage unit 305a.

The EPG 320 includes a plurality of pieces of program information each of which includes a broadcast day, a broadcast period, a channel number, a title, and a comment. It should be noted here that the mark “new” put before the title of a program indicates that the program is a new program.

The control unit 305 reads the EPG 320 from the EPG storage unit 305a, and refers to the column “title” to retrieve programs to which the mark “new” is attached. In this example, the control unit 305 retrieves “Midsummer Sonata” to be broadcast from 9 p.m. on August 13 (Sat) on Channel 8 and “Trip To World Heritage Sites” to be broadcast from 8 p.m. on August 14 (Sun) on Channel 4.

After retrieving a program with the mark “new”, the control unit 305 retrieves, from the EPG 320, programs having the same title as the program, and detects a broadcast pattern of the program. For example, it is detected that a program “Midsummer Sonata” is broadcast from 9 p.m. to 10 p.m. every Saturday on Channel 8. Having detected the broadcast pattern, the control unit 305 generates a piece of preset information, and writes it into the preset table. Description of the preset information and the preset table is omitted here since they are the same as those described in Embodiment 1.

The control unit 305 instructs the tuner 302 to select a channel based on the preset information, and instructs the signal processing unit 303 to output program data to the recording unit 306. Description of the recording process is omitted here since it is the same as that described in Embodiment 1.

After the program recording process, the recommendation list generating unit 305b of the control unit 305 generates the title information of the recorded programs, and creates a recommendation list based on the generated title information. The following describes how to create the recommendation list when, as an example, the program “Midsummer Sonata” broadcast on August 13 is recorded.

The recommendation list generating unit 305b reads the broadcast date/time, channel number, and title of the program from the EPG 320. The recommendation list generating unit 305b further judges, by referring to the EPG 320, that this is the first broadcast of the program, and it is broadcast longer than normal.

The recommendation list generating unit 305b generates a piece of title information that includes broadcast date/time “8/13 21:00”, a mark “LONG” that indicates an extended broadcast, channel number “8”, the number of broadcasts “01”, and title “Midsummer Sonata”. The recommendation list generating unit 305b writes the generated piece of title information into the recommendation list.

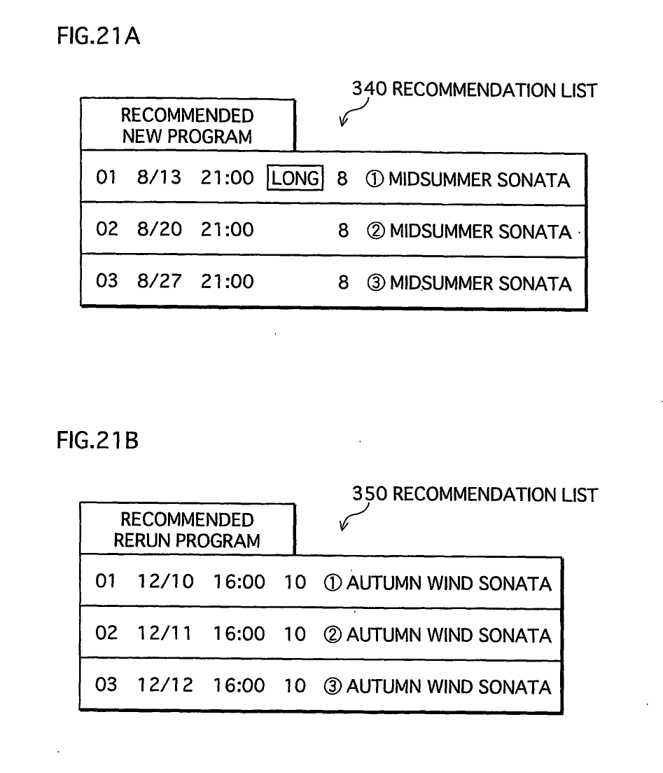

A recommendation list 340 shown in FIG. 21A contains the information that has been collected when the first to third episodes of “Midsummer Sonata” have been broadcast. As shown in FIG. 21A, a title “Recommended New Program”, which indicates that the program series is a new program, is added to the recommendation list 340.

Recording Rerun Programs

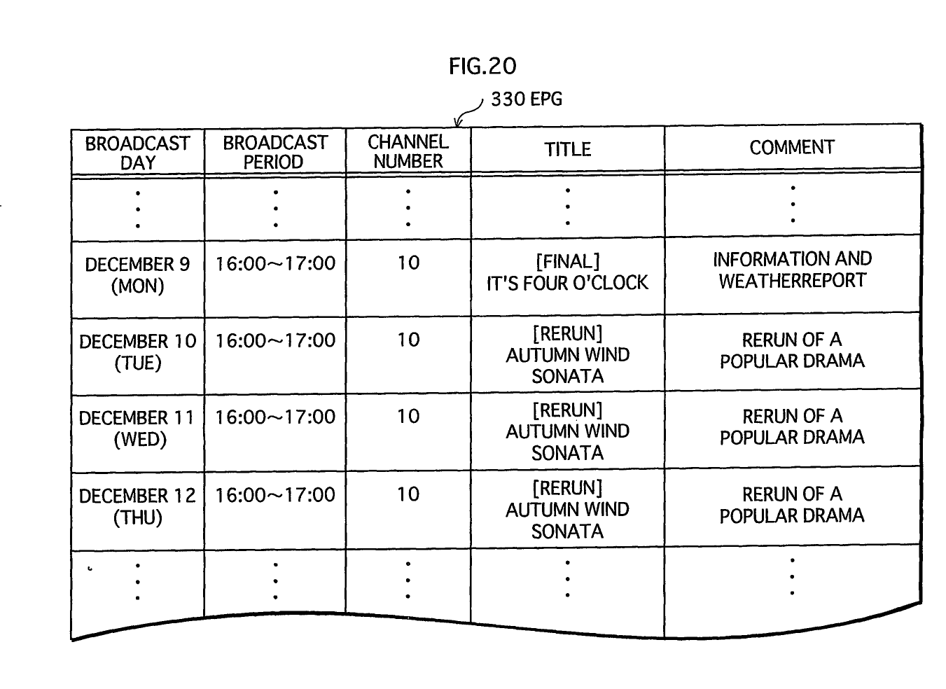

The control unit 305 performs the following on a regular basis or each time a latest EPG is stored in the EPG storage unit 305a. It is presumed here that the EPG 330, which is shown in FIG. 20, is stored as the latest EPG in the EPG storage unit 305a.

The EPG 330 includes a plurality of pieces of program information each of which includes a broadcast day, a broadcast period, a channel number, a title, and a comment. It should be noted here that the mark “rerun” put before the title of a program indicates that the program is a new program, and that the mark “final” put before the title of a program indicates that the program is a final episode of the program series.

The control unit 305 reads the EPG 330 from the EPG storage unit 305a, and refers to the column “title” to retrieve programs to which the mark “rerun” is attached. In this example, the control unit 305 retrieves “Autumn Wind Sonata” to be broadcast from 4 p.m. on December 10 (Tue) on Channel 10, “Autumn Wind Sonata” to be broadcast from 4 p.m. on December 11 (Wed) on Channel 10, and “Autumn Wind Sonata” to be broadcast from 4 p.m. on December 12 (Thu) on Channel 10.

The control unit 305 refers to the columns “title” and “comment” of the EPG 330 to compare the above three rerun programs. In this example, the comparison reveals that the three rerun programs have the same title and comment, and therefore the control unit 305 judges that the three rerun programs belong to the same program series. When it detects a program series, the control unit 305 refers to the column “broadcast day” of the EPG 330 and detects a broadcast pattern of the program series and the broadcast day on which the first episode of the rerun program is broadcast.

The control unit 305, in the present example, detects from the EPG 330 that the broadcast pattern of “Autumn Wind Sonata” is Monday through Friday. Further, the control unit 305 judges that the first episode of the rerun of “Autumn Wind Sonata” is broadcast on December 10 (Tue), from the fact that another program “It's Four O'clock” is to be broadcast for the same period and on the same channel as “Autumn Wind Sonata” before December 10 (Tue).

Having detected the broadcast pattern and the broadcast day of the first episode, the control unit 305 generates a piece of preset information including the broadcast pattern, broadcast period, channel number, and recording start day, and writes the generated piece of preset information into the preset table.

The control unit 305 instructs the tuner 302 to select a channel based on the preset information, and instructs the signal processing unit 303 to output program data to the recording unit 306.

After the program recording process, the recommendation list generating unit 305b of the control unit 305 generates the program information of the recorded programs, and creates a recommendation list based on the generated program information. The following describes how to create the recommendation list when, as an example, the program “Autumn Wind Sonata” broadcast on December 10 is recorded.

The recommendation list generating unit 305b reads the broadcast date/time, channel number, and title of the program from the EPG 330. The recommendation list generating unit 305b further judges, by referring to the EPG 330, that this is the first broadcast of the program.

The recommendation list generating unit 305b generates a piece of program information that includes broadcast date/time “12/9 16:00”, channel number “10”, the number of broadcasts “01”, and title “Autumn Wind Sonata”. The recommendation list generating unit 305b writes the generated piece of program information into the recommendation list.

A recommendation list 350 shown in FIG. 21B contains the information that has been collected when the first to third episodes of “Autumn Wind Sonata” have been broadcast. As shown in FIG. 21B, a title “Recommended Rerun Program”, which indicates that the program series is a rerun program, is added to the recommendation list 350.

Operation

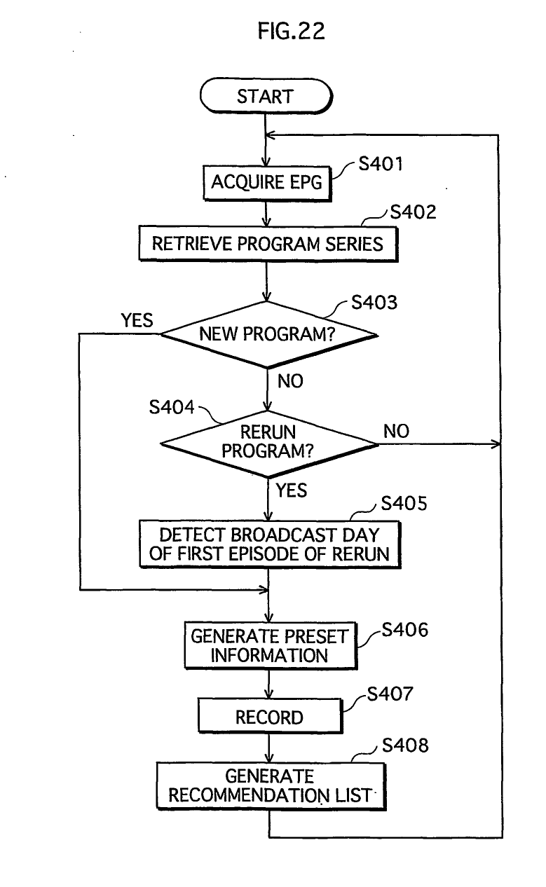

Here, the operation of the program recording apparatus 300 will be explained with reference to the flowchart shown in FIG. 22.

The control unit 305 acquires the EPG from the EPG storage unit 305a (step S401). The control unit 305 retrieves program series from the acquired EPG (step S402). More specifically, the control unit 305 refers to the column “title” in the EPG and retrieves programs with the marks “new” indicating new programs and “rerun” indicating rerun programs.

If it detects no program with the mark “new” (“NO” in step S403), and no program with the mark “rerun” (“NO” in step S404), the control unit 305 returns to step S401.

If it retrieves a program with the mark “new” (“YES” in step S403), the control unit 305 goes to step S406. If it detects no program with the mark “new” (“NO” in step S403), and detects a program with the mark “rerun” (“YES” in step S404), the control unit 305 detects the broadcast day of the first episode of the rerun (step S405). The control unit 305 then refers to the EPG to detect the broadcast pattern of the program series, and generate the preset information (step S406). The control unit 305, the 304, and the 306 record the program series in accordance with the preset information (step S407). The program information of the program that was recorded in step S407 is generated, and a recommendation list is generated from the generated program information (step S408).

It should be noted here that if it is judged as “YES” in step S403, the control does not necessarily go to step S406, but may go to step S404 to judge whether a rerun program has been detected.

<Modification>

Here, a program recording apparatus, which is a modification of Embodiment 2 and generates a recommendation list for convenience of the user when the titles of a program series are each composed of a main title and a sub title, will be explained.

The construction of the program recording apparatus is not illustrated since it is the same as that of the program recording apparatus 300.

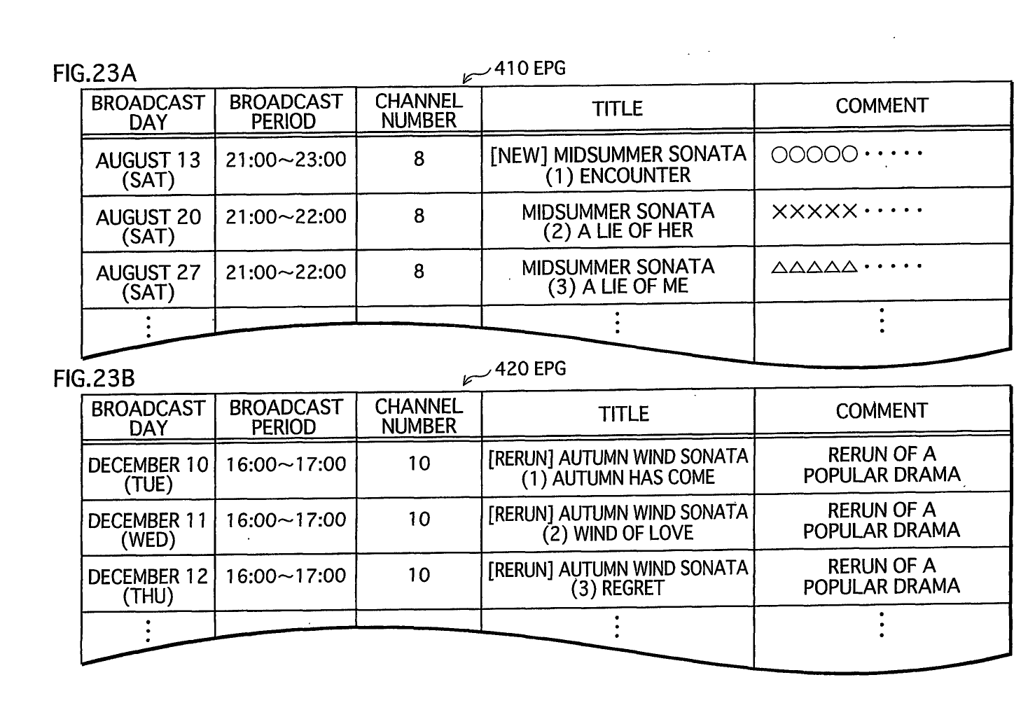

Suppose, for example, that the program recording apparatus records a program series and generates a recommendation list based on the EPG 410 shown in FIG. 23A. The titles of the program series “Midsummer Sonata” are each composed of a main title and a sub title, different from the titles shown in the EPG 320 (FIG. 19). The title of the first episode is “Midsummer Sonata (1) Encounter”, the title of the second episode is “Midsummer Sonata (2) A Lie Of Her”, and the title of the third episode is “Midsummer Sonata (3) A Lie Of Me”.

The following explanation focuses on how the program recording apparatus generates the title information for the second episode of the program series. The program recording apparatus extracts the title of the second episode “Midsummer Sonata (2) A Lie Of Her” from the EPG 410, and further extracts “Midsummer Sonata (1) Encounter” which is the title of the first episode that is broadcast a week before, or extracts “Midsummer Sonata (3) A Lie Of Me” which is the title of the third episode that is broadcast a week after. Here, it is presumed, as an example, that the program recording apparatus extracts “Midsummer Sonata (3) A Lie Of Me” which is the title of the third episode.

The program recording apparatus compares the titles “Midsummer Sonata (2) A Lie Of Her” and “Midsummer Sonata (3) A Lie Of Me” and judges whether the two titles have a same character sequence at the beginning of the titles. In this example, both titles contain “Midsummer Sonata” at the beginning thereof. Therefore, the program recording apparatus removes “Midsummer Sonata” and extracts “(2) A Lie Of Her” from the title of the second episode.

The program recording apparatus then generates a piece of title information that includes broadcast date/time “8/13 21:00”, a mark “LONG” that indicates an extension of the broadcast period, channel number “8”, and the extracted title “(2) A Lie Of Her”. The program recording apparatus writes the generated piece of title information into the recommendation list. The program recording apparatus adds the removed common character sequence “Midsummer Sonata” to the title of the recommendation list.

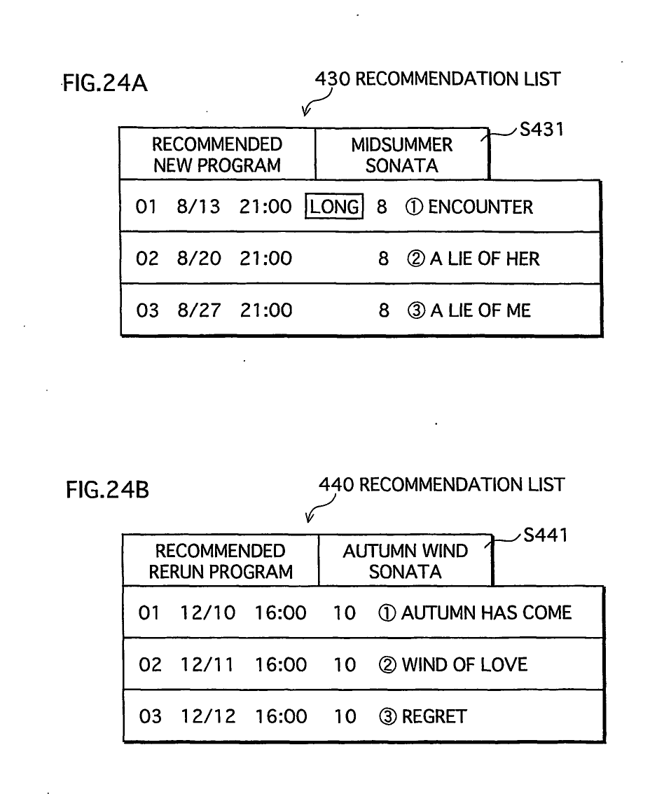

A recommendation list 430 shown in FIG. 24A contains the information that has been collected when the first to third episodes of “Midsummer Sonata” have been broadcast. As shown in FIG. 24A, the title of the recommendation list is composed of “Recommended New Program”, which indicates that the program series is a new program, and the main title of the program series “Midsummer Sonata”. Each piece of title information includes only the sub title which is a difference from other titles and is a remaining portion of the title after the main title (the common character sequence) is removed.

The program recording apparatus follows a procedure similar to the above-described one to generate a recommendation list based on the EPG 420 shown in FIG. 23B.

The titles of the program series “Autumn Wind Sonata” are each composed of a main title and a sub title, different from the titles shown in the EPG 330 (FIG. 20). The title of the first episode is “Autumn Wind Sonata (1) Autumn Has Come”, the title of the second episode is “Autumn Wind Sonata (2) Wind Of Love”, and the title of the third episode is “Autumn Wind Sonata (3) Regret”.

A recommendation list 440 shown in FIG. 24B contains the information that has been collected when the first to third episodes of “Autumn Wind Sonata” have been broadcast. As shown in FIG. 24B, the title of the recommendation list is composed of “Recommended Rerun Program”, which indicates that the program series is a rerun program, and the main title of the program series “Autumn Wind Sonata”. Each piece of title information includes only the sub title which is a difference from other titles and is a remaining portion of the title after the main title (the common character sequence) is removed.

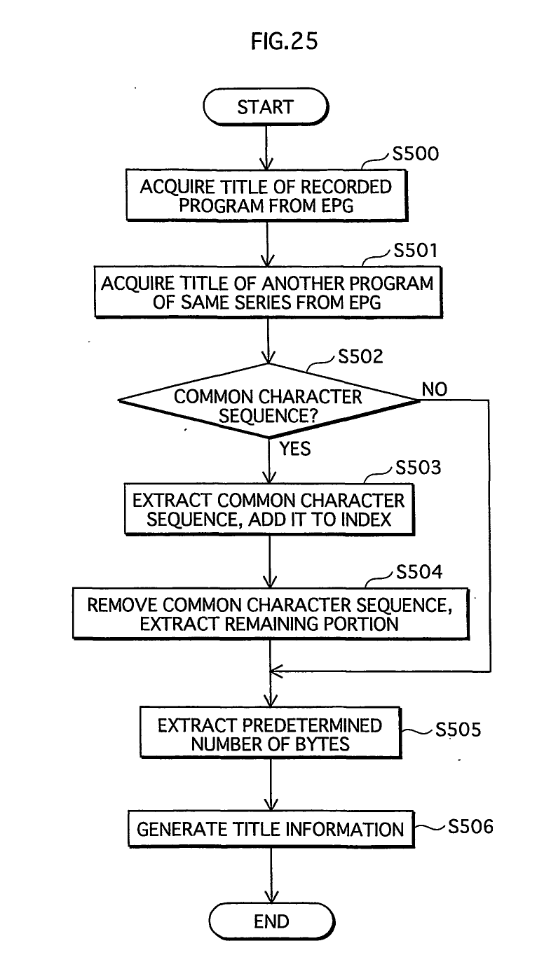

The operation of the program recording apparatus is the same as that of the program recording apparatus 300 shown in the flowchart of FIG. 22. However, the recommendation list generating process performed in step S408 of FIG. 22 includes the characteristics of the present program recording apparatus. FIG. 25 is a flowchart showing the detail of step S408 performed by the present program recording apparatus.

The program recording apparatus acquires the title of a program recorded in step S407 from the EPG stored therein (step S500). The program recording apparatus then acquires the title of another program of the same program series (step S501). The program recording apparatus compares the two titles acquired in steps S500 and S501.

If the two titles do not contain a same character sequence at the beginning of the titles (“NO” in step S502), the control goes to step S505. If the two titles contain a same character sequence at the beginning of the titles (“YES” in step S502), the program recording apparatus extracts the common character sequence from the title acquired in step S500, and adds the extracted character sequence to the index of the recommendation list (step S503). The program recording apparatus then extracts the remaining portion of the title after the common character sequence is removed therefrom (step S504).

The program recording apparatus then extracts a character sequence of a predetermined number of bytes from the beginning of the title acquired in step S500 or the title after the common character sequence was removed therefrom in step S504 (step S505), and generates a piece of title information containing the extracted character sequence having the predetermined number of bytes (step S506).

<Other Modifications>

As stated earlier, the present invention relates to a program recording apparatus for retrieving new or rerun program series from the EPG, recording each broadcast of the new or rerun program series starting with their first broadcast, and generating a title list of the recorded programs.

The present invention is not limited to the program recording apparatus 300 described above as a specific example, but may be modified as follows.

(1) In Embodiment 2, the program recording apparatus retrieves new or rerun program series. However, not limited to this, the program recording apparatus of the present invention may retrieve program series other than the new or rerun program series. Also, the program recording apparatus may not necessarily retrieve both of new and rerun program series, but may retrieve one of them from the EPG. For example, the program recording apparatus may retrieve program series using a retrieval algorithm that is different for each broadcasting station. This will be explained more specifically using an example.

As is the case with the above embodiment, the EPG includes a plurality of pieces of program information each of which includes a broadcast date/time, a channel number, a title, and a comment, where the plurality of pieces of program information are classified into groups corresponding to broadcasting stations that are identified by the broadcasting station codes.

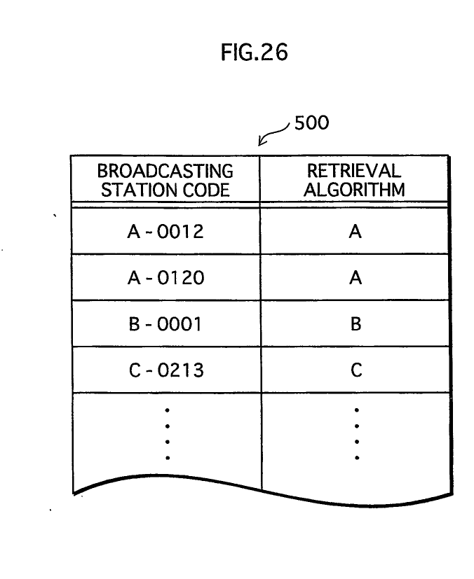

The program recording apparatus stores a table 500 shown in FIG. 26. The table 500 is a table that shows correspondence between the broadcasting station codes and retrieval algorithms. In this example, there are three retrieval algorithms: A, B, and C. The retrieval algorithm A is used for retrieving new and rerun programs. The retrieval algorithm B is used for retrieving new programs. The retrieval algorithm B is used for retrieving rerun programs.

The table 500 shows retrieval algorithms used for retrieving program series from the program information of broadcasting stations that are identified by the broadcasting station codes. For example, to retrieve program series from the program information of the broadcasting station that is identified by the broadcasting station code “A-0012”, the retrieval algorithm A is used. Also, to retrieve program series from the program information of the broadcasting station that is identified by the broadcasting station code “B-0001”, the retrieval algorithm B is used.

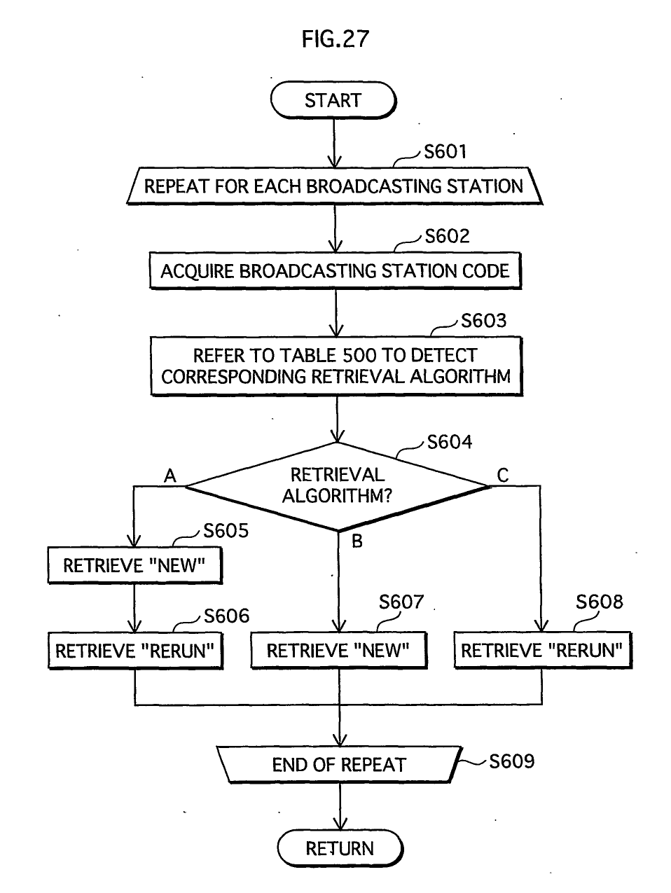

The operation in the program series retrieving process by the program recording apparatus will be described using a flowchart shown in FIG. 27. The overall operation of the program recording apparatus is the same as that of the program recording apparatus 300 shown in FIG. 22. The operation shown in FIG. 27 is a detail of step S402 shown in FIG. 22.

The program recording apparatus repeats, for each broadcasting station, the steps S601 through S609 to retrieve program series from the EPG stored therein.

The program recording apparatus acquires a broadcasting station code from the EPG (step S602). The program recording apparatus refers to the table 500 stored therein to detect a retrieval algorithm that corresponds to the acquired broadcasting station code (step S603).

If the retrieval algorithm is “A” (“A” in step S604), the program recording apparatus retrieves the mark “new” that indicates a new program, from the EPG (step S605), and retrieves the mark “rerun” that indicates a rerun program (step S606). If the retrieval algorithm is “B” (“B” in step S604), the program recording apparatus retrieves the mark “new” that indicates a new program, from the EPG (step S607). If the retrieval algorithm is “C” (“C” in step S604), the program recording apparatus retrieves the mark “rerun” that indicates a rerun program (step S608).

After the retrieval is completed for each broadcasting station shown in the EPG (step S609), the program recording apparatus returns to step S403 of FIG. 22 to continue processing of steps.

(2) In the above embodiment, the program recording apparatus records the program series in a storage unit (hard disk) embedded therein. However, not limited to this, the program recording apparatus of the present invention may be provided with other drives such as a DVD drive and a BD drive as well as the hard disk drive unit, and may record program series in a plurality of types of recording mediums such as hard disk, DVD-RAM, and BD-RE.

In such a case, the program recording apparatus may change the number of characters of each title displayed in the recommendation list, depending on the type of recording medium in which the program series and the recommendation list are recorded.

The number of characters of each title displayed in the recommendation list may be determined as follows, for example: (a) the program recording apparatus prestores therein information indicating a predetermined number of characters; (b) a different number of characters is determined for each type of recording medium; and (c) the program recording apparatus determines the number of characters that conforms to an attribute of the television to which the program recording apparatus is connected.

(3) The present invention may be methods shown by the above. Furthermore, the methods may be a computer program realized by a computer, and may be a digital signal of the computer program.

Furthermore, the present invention may be a computer-readable recording medium apparatus such as a flexible disk, a hard disk, CD-ROM, MO, DVD, DVD-ROM, DVD RAM, BD (Blu-ray Disc), or a semiconductor memory, that stores the computer program or the digital signal. Furthermore, the present invention may be the computer program or the digital signal recorded on any of the aforementioned recording medium apparatuses.

Furthermore, the present invention may be the computer program or the digital signal transmitted on a electric communication line, a wireless or wired communication line, or a network of which the Internet is representative.

Furthermore, the present invention may be a computer system that includes a microprocessor and a memory, the memory storing the computer program, and the microprocessor operating according to the computer program.

Furthermore, by transferring the program or the digital signal to the recording medium apparatus, or by transferring the program or the digital signal via a network or the like, the program or the digital signal may be executed by another independent computer system.

(4) The present invention may be a LSI being an integrated circuit that achieves part or all of the function blocks of the program recording apparatus described in any of the above-described embodiments or modifications. The LSI may be a separate chip corresponding to part of the function blocks or may be a chip corresponding to all of the function blocks.

It should be noted here that although the term LSI is used here, it may be called IC, system LSI, super LSI, ultra LSI or the like, depending on the level of integration.

Also, the integrated circuit is not limited to the LSI, but may be achieved by a dedicated circuit or a general purpose processor. It is also possible to achieve the integrated circuit by using the FPGA (Field Programmable Gate Array) that can be re-programmed after it is manufactured, or a reconfigurable processor that can reconfigure the connection and settings of the circuit cells inside the LSI.

Furthermore, a technology for an integrated circuit that replaces the LSI may appear in the near future as the semiconductor technology improves or branches into another technologies. In that case, the new technology may be incorporated into the integration of the functional blocks constituting the present invention as described above. Such possible technologies include biotechnology.

(5) The present invention may be any combination of the above-described embodiments and modifications.

<Summary>

As described above, the present invention is a program recording apparatus for receiving and recording a program, characterized by comprising: a series retrieving unit operable to retrieve, from a program guide that contains information of a plurality of programs, information of a program series composed of two or more programs related to each other; and a series recording unit operable to receive and record the two or more programs in accordance with the information of the program series retrieved by the series retrieving unit.

With the above-stated construction in which the program recording apparatus retrieves information of a program series and records each program contained in the program series, the user is not required to enter a recording instruction into the program recording apparatus for each program that the user desires to record. Also, since the program recording apparatus records each program contained in the program series, the program recording apparatus prevents the user from failing to record a program that the user desires to record by forgetting to enter the recording instruction for the program.

In the above-described program recording apparatus, the series retrieving unit may store therein a plurality of retrieval algorithms, select one or more retrieval algorithms from the plurality of retrieval algorithms, and retrieve the program series in accordance with the selected one or more retrieval algorithms.

With the above-stated construction in which the series retrieving unit stores therein a plurality of retrieval algorithms, it is possible to retrieve a variety of program series.

In the above-described program recording apparatus, the series retrieving unit may select the one or more retrieval algorithms in accordance with a broadcasting station that broadcasts the program series.

With the above-stated construction, it is possible to retrieve a program series more efficiently by specifying a retrieval algorithm based on the characteristics or the like of the broadcasting station.

In the above-described program recording apparatus, the plurality of retrieval algorithms stored in the series retrieving unit may include an algorithm for retrieving new program information, which indicates a new program series, from the program guide, and the series recording unit generates recording presetting information that indicates receiving and recording each program contained in the new program series indicated by the retrieved new program information, and receives and records each program contained in the new program series by referring to the generated recording presetting information.

With the above-stated construction, the program recording apparatus refers to the program guide and recognizes that a new program is broadcast, and records the new program. This eliminates the user's need to enter a recording instruction into the program recording apparatus for each program that the user desires to record. There are many users who fail to watch the first episode of a program series and lose all interest in watching the following episodes. However, the program recording apparatus of the present invention prevents the user from failing to watch the first episode of a program series since it never fails to record the first episode of the program series.

In the above-described program recording apparatus, the plurality of retrieval algorithms stored in the series retrieving unit may include an algorithm for retrieving rerun program information, which indicates a rerun program series, from the program guide, and the series recording unit generates recording presetting information that indicates receiving and recording each program contained in the rerun program series indicated by the retrieved rerun program information, and receives and records each program contained in the rerun program series by referring to the generated recording presetting information.

With the above-stated construction, the program recording apparatus refers to the program guide and recognizes that a rerun program is broadcast, and records the rerun program. This eliminates the user's need to enter a recording instruction into the program recording apparatus for each program that the user desires to record.

In the above-described program recording apparatus, the series retrieving unit may retrieve, from the program guide, a broadcast day on which a first episode of a rerun program series is broadcast.

With the above-stated construction, the program recording apparatus of the present invention can detect the broadcast day on which the first episode of a rerun program series is broadcast, which is difficult for the user since no TV program guide indicates a day on which the first episode of a rerun program series is broadcast.

The above-described program recording apparatus is further characterized by generating a program list used to identify each program contained in the recorded program series.

With the above-stated construction, the user can refer to the program list and select a program to watch, among the recorded programs.

The above-described program recording apparatus further comprising: an acquiring unit operable to acquire a first title being a title of a first program contained in the program series; an extracting unit operable to extract a first difference from the first title, the first difference being a portion of the first title and not being contained in a second title being a title of a second program which is contained in the same program series as the first program; and a program list generating unit operable to generate the program list based on the first difference extracted by the extracting unit.

With the above-stated construction, the program list includes the first difference that is a portion of the first title and is not contained in the second title. This facilitates identifying the first program even if the first and second titles include a same character sequence in common.

In the above-described program recording apparatus, the acquiring unit may acquire the first and second titles from the program guide, and the extracting unit may extract the first difference by removing, from the first title, one or more characters that are contained in both the first and second titles.

With the above-stated construction, the user does not need to enter the title since the program recording apparatus acquire the first and second titles from the program guide. Furthermore, the program recording apparatus extracts the first difference with reliability since it removes a same character sequence contained in the first and second titles in common, from the first title.

In the above-described program recording apparatus, the extracting unit further extracts a character sequence having a predetermined number of bytes from the extracted first difference, and the program list generating unit generates the program list, which contains the character sequence having the predetermined number of bytes.

With the above-stated construction, the program recording apparatus generates a unique program list that does not depend on, for example, a format set in a recording medium.

In the above-described program recording apparatus, the program list generating unit may include the same character sequence contained in the first and second titles into a title of the program list.

With the above-stated construction, the program list shows titles of programs that are different from each other, and the title of the program list shows the same character sequence contained in the program titles. This enables the user to recognize the main title of the program series from the title of the program list. This facilitates the user's selection of a program that the user desires to view.

In the above-described program recording apparatus, the series retrieving unit may receive retrieval information that includes at least one of: (a) a period of broadcasting; and (b) a channel, and retrieve information of a program series from the program guide, based on the received retrieval information.

Each user has his/her own tastes. Some users prefer drama series that are often broadcast in prime time. Some users prefer rerun programs that are often broadcast in the early-evening hours. Some users prefer specific broadcasting stations. The above-stated construction enables the program recording apparatus to record programs that suit the user's tastes by receiving the retrieval information from the user, and retrieving the information of the program series using the received retrieval information.

### INDUSTRIAL APPLICABILITY

The present invention can be used in the industry for manufacturing and distributing hard disk recorders for home use or the like to manufacture and distribute products that have a multi-function and suit the user's demands.

1. A program list generating apparatus for generating a program list, comprising:
an acquiring unit operable to acquire a first title being a title of a first program;
an extracting unit operable to extract a first difference from the first title, the first difference being a portion of the first title and not being contained in a second title being a title of a second program; and
a program list generating unit operable to generate the program list based on the first difference extracted by the extracting unit.

2. The program list generating apparatus of claim 1, wherein
the acquiring unit acquires the first and second titles from a program guide which shows information of a plurality of programs, and
the extracting unit extracts the first difference by removing, from the first title, one or more characters that are contained in both the first and second titles.

3. The program list generating apparatus of claim 2, wherein
the extracting unit further extracts a character sequence having a predetermined length from the first difference, and
the program list generating unit generates the program list, which contains the character sequence having the predetermined length extracted by the extracting unit.

4. The program list generating apparatus of claim 3, wherein
the extracting unit prestores information indicating a number of bytes that corresponds to the predetermined length, and extracts, from the first difference, the character sequence having the number of bytes indicated by the information.

5. The program list generating apparatus of claim 4, wherein
if a character sequence constituting the first difference is shorter than the character sequence having the number of bytes, the extracting unit combines part or all of the one or more characters with part or all of the character sequence constituting the first difference to generate a combination character sequence having the number of bytes indicated by the information, and
the program list generating unit generates the program list, which contains the combination character sequence generated by the extracting unit.

6. The program list generating apparatus of claim 3 further comprising:
a receiving unit operable to receive the first program; and
a recording unit operable to record the received first program into a recording medium in conformity with a first recording format, wherein
the extracting unit extracts, from the first difference, the character sequence having the predetermined length, which corresponds to the first recording format.

7. The program list generating apparatus of claim 6, wherein
the recording unit selects the first recording format among a plurality of recording formats that respectively correspond to a plurality of types of recording mediums, and records the first program into the recording medium in conformity with the first recording format, and
the extracting unit prestores information that indicates a correspondence between the plurality of recording formats and one or more lengths, and extracts, from the first difference, a character sequence having a length that corresponds to the first recording format.

8. The program list generating apparatus of claim 3, being connected to a monitor, wherein
the character sequence, which is extracted from the first difference by the extracting unit, conforms to a display format of the program list on the monitor.

9. The program list generating apparatus of claim 8 further comprising:
a display format receiving unit operable to receive a display format of the program list on the monitor, wherein
the extracting unit prestores information that indicates a correspondence between the plurality of display formats and one or more lengths for each of a plurality of display formats, and extracts, from the first difference, a character sequence having a length that corresponds to the display format received by the display format receiving unit.

10. The program list generating apparatus of claim 9, wherein
the program list generating unit determines a font size of the character sequence extracted by the extracting unit, in accordance with the display format received by the display format receiving unit.

11. The program list generating apparatus of claim 9, wherein
the program list generating unit determines a font type of the character sequence extracted by the extracting unit, in accordance with the display format received by the display format receiving unit.

12. The program list generating apparatus of claim 3, being connected to a monitor, wherein
the character sequence extracted by the extracting unit conforms to an attribute of the monitor.

13. The program list generating apparatus of claim 12 further comprising:
a monitor information acquiring unit operable to acquire monitor information indicating a resolution of the monitor, from the monitor, wherein
the extracting unit prestores information that indicates a correspondence between a plurality of resolutions and one or more lengths, and extracts, from the first difference, a character sequence having a length that corresponds to the resolution indicated by the monitor information acquired by the monitor information acquiring unit.

14. The program list generating apparatus of claim 2, wherein
the first and second programs are broadcast on different days, on a same channel, and for a same time period.

15. The program list generating apparatus of claim 1 further comprising:
a receiving unit operable to receive the first and second programs; and
a recording unit operable to record the received first and second programs, wherein
the extracting unit extracts the first difference from the first title, and extracts a second difference from the second title, the first and second differences being respectively portions of the first and second titles and being different from each other, and
the program list generated by the program list generating unit contains the first and second differences.

16. The program list generating apparatus of claim 15 further comprising:
a program list outputting unit operable to output the generated program list to an external monitor connected to the program list generating apparatus;
a program selection receiving unit operable to receive a selection of a program that is made by a user viewing the program list displayed on the monitor; and
a program reproduction unit operable to output reproduction of the program selected by the user, to the monitor.

17. A program list generating method for generating a program list, comprising the steps of:
acquiring a first title being a title of a first program;
extracting a first difference from the first title, the first difference being a portion of the first title and not being contained in a second title being a title of a second program; and
generating the program list based on the extracted first difference.

18. A program list generating program for use in a program list generating apparatus for generating a program list, comprising the steps of:
acquiring a first title being a title of a first program;
extracting a first difference from the first title, the first difference being a portion of the first title and not being contained in a second title being a title of a second program; and
generating the program list based on the extracted first difference.

19. The program list generating program of claim 18 being recorded in a computer-readable recording medium.

20. An integrated circuit of a program list generating apparatus for generating a program list, comprising:
an acquiring unit operable to acquire a first title being a title of a first program;
an extracting unit operable to extract a first difference from the first title, the first difference being a portion of the first title and not being contained in a second title being a title of a second program; and
a program list generating unit operable to generate the program list based on the first difference extracted by the extracting unit.
